(19) United States
(12) Patent Application Publication
(10) Pub. No.: US 2025/0271162 A1
(43) Pub. Date: Aug. 28, 2025

(54) HVAC MONITORING AND CONTROL SYSTEM AND METHOD

(71) Applicants: Kenneth Ray Green, Crossroads, TX (US); Douglas Hiram Morse, Decatur, TX (US)

(72) Inventors: Kenneth Ray Green, Crossroads, TX (US); Douglas Hiram Morse, Decatur, TX (US)

(21) Appl. No.: 19/204,909

(22) Filed: May 12, 2025

Related U.S. Application Data
(63) Continuation-in-part of application No. 18/382,580, filed on Oct. 23, 2023.
(63) Continuation-in-part of application No. 17/391,375, filed on Aug. 2, 2021.
(63) Continuation-in-part of application No. 17/734,382, filed on May 2, 2022, now Pat. No. 12,298,039.
Application No. 18/382,580 is a continuation-in-part of application No. 17/734,406, filed on May 2, 2022, now Pat. No. 11,796,200.
Application No. 17/734,406 is a continuation of application No. 16/855,238, filed on Apr. 22, 2020, now Pat. No. 11,326,798.
Application No. 16/855,238 is a continuation-in-part of application No. 15/902,452, filed on Feb. 22, 2018, now abandoned.
Application No. 15/902,452 is a continuation-in-part of application No. 16/580,717, filed on Sep. 24, 2019, now abandoned.
Application No. 16/580,717 is a continuation-in-part of application No. 16/747,422, filed on Jan. 20, 2020, now Pat. No. 11,428,448.
(60) Provisional application No. 62/938,132, filed on Nov. 20, 2019.
(60) Provisional application No. 62/886,020, filed on Aug. 13, 2019.
(60) Provisional application No. 62/854,676, filed on May 30, 2019.
(60) Provisional application No. 62/750,383, filed on Oct. 25, 2018.
(60) Provisional application No. 62/462,570, filed on Feb. 23, 2017.

(51) Int. Cl. F24F 11/36; F24F 11/52; F24F 11/526; F24F 11/58; F24F 11/84; F24F 110/10; F24F 110/20; F24F 110/65; G05B 23/02

(52) U.S. Cl. CPC F24F 11/36; F24F 11/526; F24F 11/58; F24F 11/84; G05B 23/027; F24F 11/52; F24F 2110/10; F24F 2110/20; F24F 2110/65; F25B 2500/22; F25B 2500/222

(57) ABSTRACT

A monitoring and control system/method for use in heating, ventilation, and air conditioning (HVAC) systems is disclosed that incorporates a digital control processor (DCP) controlling and monitoring the operation of a HVAC system incorporating evaporator elements (refrigerant valve (EFV), coil (HEC), fan (HEF), relay (HER)) and condenser elements (refrigerant valve (CRV), coil (HCC), fan (HCF), compressor motor (HCM), relay (HCR)) via a sensor/control bus. The HVAC elements may be monitored by the DCP using sensors measuring ambient refrigerant gas (RGS), refrigerant temperature (RTS), refrigerant pressure (RPS), duct air flow (AFS), ambient temperature/humidity (THS), and operational current/voltage (CVS). The DCP is configured to activate an alarm status indicator (ASI) and HVAC shutdown control (HSC) in the event of a detected HVAC system fault and interact with a wireless user interface (WUI) and mobile user device (MUD) to enable remote monitoring and control of the HVAC system.

### CROSS REFERENCE TO RELATED APPLICATIONS

### Continuation-In-Part Application (CIP)

This is a continuation-in-part patent application (CIP) of and incorporates by reference United States Utility Patent Application for REFRIGERANT LEAK DETECTION AND MITIGATION SYSTEM AND METHOD by inventors Kenneth Ray Green and Douglas Hiram Morse, filed electronically with the USPTO on 2023 Oct. 23, with Ser. No. 18/382,580, EFS ID 48749547, confirmation number 4181, docket KRG-2023-10.

This is a continuation-in-part patent application (CIP) of and incorporates by reference United States Utility Patent Application for FAILSAFE GAS LEAK DETECTION AND MITIGATION SYSTEM AND METHOD by inventors Kenneth Ray Green and Douglas Hiram Morse, filed electronically with the USPTO on 2022 May 2, with Ser. No. 17/734,382, EFS ID 45610922, confirmation number 1198, docket KRG-2022-05, issued as U.S. Pat. No. 12,298,039 on 2025 May 13.

This is a continuation-in-part patent application (CIP) of and incorporates by reference United States Utility Patent Application for AIR DISINFECTANT SYSTEM AND METHOD by inventors Kenneth Ray Green and Douglas Hiram Morse, filed electronically with the USPTO on 2021 Aug. 2, with Ser. No. 17/391,375, EFS ID 43402171, confirmation number 8335, docket KRG-2022-04, issued as U.S. Pat. No. XX, XXX, XXX on 20YY-MM-DD.

### Continuation-In-Part Application (CIP)

United States Utility Patent Application for REFRIGERANT LEAK DETECTION AND MITIGATION SYSTEM AND METHOD by inventors Kenneth Ray Green and Douglas Hiram Morse, filed electronically with the USPTO on 2023 Oct. 23, with Ser. No. 18/382,580, EFS ID 48749547, confirmation number 4181, docket KRG-2023-10, is a continuation-in-part patent application (CIP) of and incorporates by reference United States Utility Patent Application for REFRIGERANT LEAK DETECTION AND MITIGATION SYSTEM AND METHOD by inventors Kenneth Ray Green and Douglas Hiram Morse, filed electronically with the USPTO on 2022 May 2, with Ser. No. 17/734,406, EFS ID 45611163, confirmation number 6626, docket KRG-2020-06, issued as U.S. Pat. No. 11,796,200 on 2023 Oct. 24.

United States Utility Patent Application for REFRIGERANT LEAK DETECTION AND MITIGATION SYSTEM AND METHOD by inventors Kenneth Ray Green and Douglas Hiram Morse, filed electronically with the USPTO on 2022 May 2, with Ser. No. 17/734,406, EFS ID 45611163, confirmation number 6626, docket KRG-2020-06, issued as United States U.S. Pat. No. 11,796,200 on 2023 Oct. 24, is a continuation patent application (CPA) of and incorporates by reference United States Utility Patent Application for REFRIGERANT LEAK DETECTION AND MITIGATION SYSTEM AND METHOD by inventors Kenneth Ray Green and Douglas Hiram Morse, filed electronically with the USPTO on 22 Apr. 2020, with Ser. No. 16/855,238, EFS ID 39231336, confirmation number 3025, docket KRG-2020-03, issued as U.S. Pat. No. 11,326,798 on 2022 May 10.

United States Utility Patent Application for REFRIGERANT LEAK DETECTION AND MITIGATION SYSTEM AND METHOD by inventors Kenneth Ray Green and Douglas Hiram Morse, filed electronically with the USPTO on 22 Apr. 2020, with Ser. No. 16/855,238, EFS ID 39231336, confirmation number 3025, docket KRG-2020-03, issued as U.S. Pat. No. 11,326,798 on 2022 May 10, is a continuation-in-part (CIP) patent application of and incorporates by reference United States Utility Patent Application for DISTRIBUTED CLIMATE-CONTROL SYSTEMS AND METHODS WITH DISTRIBUTED PROTECTION AGAINST REFRIGERANT LOSS by applicant Laura D. Green, inventors Kenneth R. Green, et al., filed electronically with the USPTO on 22 Feb. 2018, with serial number 15/902, 452, EFS ID 31861708, confirmation number 1253, docket KGAC-11: (KRG-2020-02).

United States Utility Patent Application for REFRIGERANT LEAK DETECTION AND MITIGATION SYSTEM AND METHOD by inventors Kenneth Ray Green and Douglas Hiram Morse, filed electronically with the USPTO on 22 Apr. 2020, with Ser. No. 16/855,238, EFS ID 39231336, confirmation number 3025, docket KRG-2020-03, issued as U.S. Pat. No. 11,326,798 on 2022 May 10, is a continuation-in-part (CIP) patent application of and incorporates by reference United States Utility Patent Application for DISTRIBUTED RESIDENTIAL CLIMATE-CONTROL SYSTEMS AND METHODS WITH DISTRIBUTED PROTECTION AGAINST REFRIGERANT LOSS by inventors Kenneth R. Green, et al., filed electronically with the USPTO on 24 Sep. 2019, with Ser. No. 16/580,717, EFS ID 37259582, confirmation number 6370, docket KGAC-13:.

United States Utility Patent Application for REFRIGERANT LEAK DETECTION AND MITIGATION SYSTEM AND METHOD by inventors Kenneth Ray Green and Douglas Hiram Morse, filed electronically with the USPTO on 22 Apr. 2020, with Ser. No. 16/855,238, EFS ID 39231336, confirmation number 3025, docket KRG-2020-03, issued as U.S. Pat. No. 11,326,798 on 2022 May 10, is a continuation-in-part (CIP) patent application of and incorporates by reference United States Utility Patent Application for REFRIGERANT METERING SYSTEM AND METHOD by inventor Kenneth R. Green, filed electronically with the USPTO on 20 Jan. 2020, with serial number 16/747, 422, EFSID 38342840, confirmation number 1232, docket KRG-2020-01.

### PCT Patent Applications

This patent application claims benefit under 35 U.S.C. § 120 and incorporates by reference PCT Patent Application for DISTRIBUTED CLIMATE-CONTROL SYSTEMS AND METHODS WITH DISTRIBUTED PROTECTION AGAINST REFRIGERANT LOSS by applicant Laura D. Green, inventors Kenneth R. Green, et al., filed electronically with the USPTO on 22 Feb. 2018, with serial number PCT/US2018/019161.

### Utility Patent Applications

This patent application claims benefit under 35 U.S.C. § 120 and incorporates by reference United States Utility Patent Application for REFRIGERANT LEAK DETECTION AND MITIGATION SYSTEM AND METHOD by inventors Kenneth Ray Green and Douglas Hiram Morse, filed electronically with the USPTO on 2022 May 2, with Ser. No. 17/734,406, EFS ID 45611163, confirmation number 6626, docket KRG-2020-06, issued as United States Patent 11, 796,200 on 2023 Oct. 24.

This patent application claims benefit under 35 U.S.C. § 120 and incorporates by reference United States Utility Patent Application for REFRIGERANT LEAK DETECTION AND MITIGATION SYSTEM AND METHOD by inventors Kenneth Ray Green and Douglas Hiram Morse, filed electronically with the USPTO on 22 Apr. 2020, with Ser. No. 16/855,238, EFS ID 39231336, confirmation number 3025, docket KRG-2020-03, issued as U.S. Pat. No. 11,326,798 on 2022 May 10.

United States Utility Patent Application for REFRIGERANT LEAK DETECTION AND MITIGATION SYSTEM AND METHOD by inventors Kenneth Ray Green and Douglas Hiram Morse, filed electronically with the USPTO on 22 Apr. 2020, with Ser. No. 16/855,238, EFS ID 39231336, confirmation number 3025, docket KRG-2020-03, issued as U.S. Pat. No. 11,326,798 on 2022 May 10, claims benefit under 35 U.S.C. § 120 and incorporates by reference United States Utility Patent Application for DISTRIBUTED CLIMATE-CONTROL SYSTEMS AND METHODS WITH DISTRIBUTED PROTECTION AGAINST REFRIGERANT LOSS by applicant Laura D. Green, inventors Kenneth R. Green, et al., filed electronically with the USPTO on 22 Feb. 2018, with Ser. No. 15/902,452, EFS ID 31861708, confirmation number 1253, docket KGAC-11: (KRG-2020-02).

United States Utility Patent Application for REFRIGERANT LEAK DETECTION AND MITIGATION SYSTEM AND METHOD by inventors Kenneth Ray Green and Douglas Hiram Morse, filed electronically with the USPTO on 22 Apr. 2020, with Ser. No. 16/855,238, EFS ID 39231336, confirmation number 3025, docket KRG-2020-03, issued as U.S. Pat. No. 11,326,798 on 2022 May 10, claims benefit under 35 U.S.C. § 120 and incorporates by reference United States Utility Patent Application for DISTRIBUTED RESIDENTIAL CLIMATE-CONTROL SYSTEMS AND METHODS WITH DISTRIBUTED PROTECTION AGAINST REFRIGERANT LOSS by inventors Kenneth R. Green, et al., filed electronically with the USPTO on 24 Sep. 2019, with Ser. No. 16/580,717, EFS ID 37259582, confirmation number 6370, docket KGAC-13:.

United States Utility Patent Application for REFRIGERANT LEAK DETECTION AND MITIGATION SYSTEM AND METHOD by inventors Kenneth Ray Green and Douglas Hiram Morse, filed electronically with the USPTO on 22 Apr. 2020, with Ser. No. 16/855,238, EFS ID 39231336, confirmation number 3025, docket KRG-2020-03, issued as U.S. Pat. No. 11,326,798 on 2022 May 10, claims benefit under 35 U.S.C. § 120 and incorporates by reference United States Utility Patent Application for REFRIGERANT METERING SYSTEM AND METHOD by Kenneth inventor R. Green, filed electronically with the USPTO on 20 Jan. 2020, with Ser. No. 16/747,422, EFSID 38342840, confirmation number 1232, docket KRG-2020-01.

### Provisional Patent Applications

United States Utility Patent Application for REFRIGERANT LEAK DETECTION AND MITIGATION SYSTEM AND METHOD by inventors Kenneth Ray Green and Douglas Hiram Morse, filed electronically with the USPTO on 22 Apr. 2020, with Ser. No. 16/855,238, EFS ID 39231336, confirmation number 3025, docket KRG-2020-03, issued as U.S. Pat. No. 11,326,798 on 2022 May 10, claims benefit under 35 U.S.C. § 119 and incorporates by reference United States Provisional Patent Application for LEAK CONTAINMENT SYSTEMS by inventors Kenneth R. Green, et al., filed electronically with the USPTO on 20 Nov. 2019, with Ser. No. 62/938, 132, EFS ID 37810820, confirmation number 6339, docket KGAC-18-P.

United States Utility Patent Application for REFRIGERANT LEAK DETECTION AND MITIGATION SYSTEM AND METHOD by inventors Kenneth Ray Green and Douglas Hiram Morse, filed electronically with the USPTO on 22 Apr. 2020, with Ser. No. 16/855,238, EFS ID 39231336, confirmation 3025, docket KRG-2020-03, issued as U.S. Pat. No. 11,326,798 on 2022 May 10, claims benefit under 35 U.S.C. § 119 and incorporates by reference United States Provisional Patent Application for LEAK DETECTION TROUBLESHOOTER by inventors Kenneth R. Green, et al., filed electronically with the USPTO on 13 Aug. 2019, with Ser. No. 62/886, 020, EFS ID 36861132, confirmation number 1376, docket KGAC-17-P.

United States Utility Patent Application for REFRIGERANT LEAK DETECTION AND MITIGATION SYSTEM AND METHOD by inventors Kenneth Ray Green and Douglas Hiram Morse, filed electronically with the USPTO on 22 Apr. 2020, with Ser. No. 16/855,238, EFS ID 39231336, confirmation number 3025, docket KRG-2020-03, issued as U.S. Pat. No. 11,326,798 on 2022 May 10, claims benefit under 35 U.S.C. § 119 and incorporates by reference United States Provisional Patent Application for AC BOX ENGINEERING, DESIGNS, AND DEVICES by inventors Kenneth R. Green, et al., filed electronically with the USPTO on 30 May 2019, with Ser. No. 62/854,676, EFS ID 36158820, confirmation number 6929, docket KGAC-16-P.

United States Utility Patent Application for DISTRIBUTED RESIDENTIAL CLIMATE-CONTROL SYSTEMS AND METHODS WITH DISTRIBUTED PROTECTION AGAINST REFRIGERANT LOSS by inventors Kenneth R. Green, et al., filed electronically with the USPTO on 24 Sep. 2019, with Ser. No. 16/580,717, EFS ID 37259582, confirmation number 6370, docket KGAC-13: , claims benefit under 35 U.S.C. § 119 and incorporates by reference United States Provisional Patent Application for DISTRIBUTED RESIDENTIAL CLIMATE-CONTROL SYSTEMS AND METHODS WITH REFRIGERANT MANAGEMENT by inventors Kenneth R. Green, et al., filed electronically with the USPTO on 25 Oct. 2018, with Ser. No. 62/750, 383, EFS ID 34113773, confirmation number 1062, docket KGAC-15-P.

United States Utility Patent Application for DISTRIBUTED CLIMATE-CONTROL SYSTEMS AND METHODS WITH DISTRIBUTED PROTECTION AGAINST REFRIGERANT LOSS by applicant Laura D. Green, inventors Kenneth R. Green, et al., filed electronically with the USPTO on 22 Feb. 2018, with Ser. No. 15/902,452, EFS ID 31861708, confirmation number 1253, docket KGAC-11: (KRG-2020-02), claims benefit under 35 U.S.C. § 119 and incorporates by reference United States Provisional Patent Application for REFRIGERANT LEAK CONTAINMENT SYSTEM by inventor Kenneth R. Green, filed electronically with the USPTO on 23 Feb. 2017, with Ser. No. 62/462,570, confirmation number 1047, docket 3286 KG-2NCG.

### PARTIAL WAIVER OF COPYRIGHT

All of the material in this patent application is subject to copyright protection under the copyright laws of the United States and of other countries. As of the first effective filing date of the present application, this material is protected as unpublished material.

However, permission to copy this material is hereby granted to the extent that the copyright has no objection to the facsimile reproduction by anyone of the patent documentation or patent disclosure, as it appears in the United States Patent and Trademark Office patent file or records, but otherwise reserves all copyright rights whatsoever.

### STATEMENT REGARDING FEDERALLY SPONSORED RESEARCH OR DEVELOPMENT

Not Applicable

### REFERENCE TO A MICROFICHE APPENDIX

Not Applicable

### FIELD OF THE INVENTION

The present invention relates to heating, ventilation, and air conditioning (HVAC) systems, and specifically monitoring and control within these HVAC systems to detect and mitigate component failure by comprehensive detection of fault conditions and component degradation. Without limitation, the present invention may have application in situations where a HVAC component has failed and the HVAC system must be shutdown or run in a fallback operational state. In these situations it is advantageous to detect both actual fault conditions and the degradation of HVAC system component performance so that maintenance technicians can be notified of the component failure or potential component failure and thus affect repairs to the HVAC system.

In many circumstances a component failure within the HVAC system occurs after a gradual decay in component function. This gradual decay in component function may be monitored by the present invention and thus point to a potential future component failure. Reporting of these functional decays in performance may be reported via wireless network to maintenance personnel so that repairs may be affected prior to actual component failure and HVAC system shutdown.

Furthermore, the present invention is specifically targeted at reducing HVAC system failures due to refrigerant leaks by monitoring the HVAC system for a refrigerant gas leak (RGL) that may be indicated by abnormal temperatures, pressures, currents, voltages, or other indicators provided by sensors placed within the HVAC system.

### BACKGROUND AND PRIOR ART

### Regulatory Background

The Clean Air Act (CAA) (42 U.S.C. § 7401 et seq.) is a comprehensive Federal law that regulates all sources of air emissions. The 1970 CAA authorized the U.S. Environmental Protection Agency (EPA) to establish National Ambient Air Quality Standards (NAAQS) to protect public health and the environment. Section 608 of the Clean Air Act prohibits the knowing release of refrigerant during the maintenance, service, repair, or disposal of air-conditioning and refrigeration equipment. The EPA requires proper refrigerant management practices by owners and operators of refrigeration and air-conditioning systems, technicians, and others.

In the fall of 2016, the EPA updated the existing requirements related to ozone depleting substances (ODS), such as CFCs and HCFCs, and extended them to substitutes such as HFCs. The updates include:
(1) More stringent requirements for repairing leaks in larger appliances;
(2) New recordkeeping for the disposal of appliances containing five to 50 pounds of refrigerant;
(3) New reporting requirement that kicks in when larger appliances leak 125% or more of their charge in a calendar year;
(4) Restricting the sale of HFC refrigerant to technicians certified under Sections 608 or 609 of the Clean Air Act; and
(5) Changes to improve readability and simplify compliance.

The following regulatory requirements apply to supermarkets and property and facility managers as of Jan. 1, 2019:

### Affected Appliances

The leak repair regulations apply to industrial process refrigeration (IPR), commercial refrigeration, and comfort cooling appliances containing 50 pounds or more of ODS or substitute refrigerant.

### Leak Rate Calculations

Owners/operators must calculate the leak rate every time ODS or substitute refrigerant is added to an appliance (unless the addition is made immediately following a retrofit, installation of a new appliance, or qualifies as a seasonal variance).

Appliance Repairs

Owners/operators must identify and repair leaks that exceed 30% for IPR, 20% for commercial refrigeration, and 10% for comfort cooling within 30 days of when the ODS or substitute refrigerant is added. Leaks must be repaired such that the leak rate is brought below the applicable leak rate.

Owners/operators of all three appliance types must perform and document both an initial and follow-up verification test of leak repairs, for appliances that exceed the applicable leak rate. An initial verification test must be performed before any additional refrigerant is added to the appliance. A follow-up verification test must be performed only after the appliance has returned to normal operating characteristics and conditions. There is no minimum timeframe.

The verification tests must demonstrate that leaks were successfully repaired. If either the initial or follow-up verification test indicates that repairs were not successful, owners/operators may conduct as many additional repairs and verification tests as needed within the 30 day repair period.

Owners/operators of IPR, commercial refrigeration, and comfort cooling equipment may request limited extensions to the 30 day (120 days if an industrial process shutdown is required) repair deadline.

If owners/operators fail to bring the leak rate below the threshold leak rate, owners/operators must create and implement a retrofit or retirement plan.

### Leak Inspections

Owners/operators must conduct leak inspections for appliances that have exceeded the applicable leak ate, according to the schedule in the schedule below. Leak inspections must be conducted by a certified technician. All visible and accessible components of an appliance must be inspected.

Quarterly or annual leak inspections are not required on appliances (or portions of appliances) that are continuously monitored by an automatic leak detection system that is audited and calibrated annually.

### Commercial Refrigeration and Industrial Process Refrigeration

For full charge >500 pounds, the frequency of leak inspections is once every three months until the owner/operator can demonstrate through leak rate calculations that the leak rate has not exceeded 20% (commercial refrigeration) or 30% (IPR) for four quarters in a row.

For full charge 50 to 500 pounds, the frequency of leak inspections is once per calendar year until the owner/operator can demonstrate through the leak rate calculations that the leak rate has not exceeded 20% (commercial refrigeration) or 30% (IPR) for one year.

### Comfort Cooling

For full charge 50 or more pounds, the frequency of leak inspections is once per calendar year until the owner/operator can demonstrate through the leak rate calculations that the leak rate has not exceeded 10% for one year.

### Retrofit or Retirement Plans

Owners/operators must create a retrofit or retirement plan within 30 days of an appliance leaking ODS or substitute refrigerant above the applicable leak rate if:
(a) The owner/operator intends to retrofit or retire rather than repair the leak; or
(b) The owner/operator fails to identify and repair the leak; or
(c) The appliance continues to leak above the applicable leak rate after required repairs and verification tests.

Retrofit or retirement plans must contain: identification and location of the appliance; type and full charge of the refrigerant in use; type and full charge of alternative refrigerant (if retrofitting); itemized procedure for converting the appliance to a different refrigerant, including changes required for compatibility with the new refrigerant (if retrofitting); plan for disposition of recovered refrigerant; plan for disposition of the appliance (if retiring); and a schedule for completion within one year.

The retrofit or retirement must be completed within one year of the plan's date unless granted extra time.

Owners/operators must repair all identified leaks as part of any retrofit.

Owners/operators may request relief from the obligation to retrofit or retire an appliance if they can establish within 180 days of the plan's date that the appliance no longer exceeds the applicable leak rate and agrees in writing to repair all identified leaks within one year of the plan's date.

### Chronically Leaking Appliances

Owners/operators must submit reports to the EPA if any appliance leaks 125% or more of its full charge in one calendar year. This report must describe efforts to identify leaks and repair the appliance.

### Recordkeeping and Reporting Requirements

Owners/operators must maintain hard or electronic copies of:
Records documenting the full charge of appliances.
Records, such as invoices, showing when service or maintenance is performed, when refrigerant is added to an appliance (or removed, in the case of disposal), when a leak inspection is performed, and when a verification test is conducted.
If using an automatic leak detection system, documentation that the system is installed and calibrated annually and records of when the monitoring system identifies a leak and the location of the leak.
Retrofit and/or retirement plans.
Requests submitted to the EPA to extend the repair or retrofit deadlines.
If a system is mothballed to suspend a deadline, maintain records documenting when the system was mothballed and when it was brought back on-line (i.e., when refrigerant was added back into the appliance).
Records to demonstrate a seasonal variance.
Reports on appliances that leak 125% or more of the full charge in a calendar year.

### Prior Art Application to Regulation Requirements

The prior art has yet to address the EPA regulatory requirements regarding refrigerant leak detection, mitigation, and the requirement for monitoring of refrigerant leaks and the associated recordkeeping requirements of these EPA regulations.

### Application to Existing HVAC Systems

Conventional HVAC systems often experience failures of refrigerant coils within the refrigerant flow loop. This may take the form of condenser or evaporator coil failures. In either case the loss of refrigerant can cause system failure in multiple locations, especially if the system incorporates a single compressor/condenser and multiple evaporator coils, as might be configured in a commercial building or other similar structure.

Prior art mechanisms to detect and/or mitigate these failures have proven unsuccessful in discriminating true refrigerant leaks from ambient hydrocarbon emissions as might be experienced from the use of cleaning solvents and/or other cleaning materials that are typically used in a commercial building context. For this reason, a system that can detect and/or mitigate refrigerant leaks in a HVAC system and provide monitoring/logging of refrigerant leaks represents a long-felt need within the HVAC servicing industry, especially in light of recently enacted EPA regulatory requirements.

United States Utility Patent Application for REFRIGERANT LEAK DETECTION AND MITIGATION SYSTEM AND METHOD by inventors Kenneth Ray Green and Douglas Hiram Morse, filed electronically with the USPTO on 2022 May 2, with Ser. No. 17/734,406, EFS ID 45611163, confirmation number 6626, docket KRG-2020-06, issued as U.S. Pat. No. 11,796,200 on 2023 Oct. 24 is incorporated here by reference and describes a method of detecting refrigerant gas leaks using a refrigerant gas sensor (RGS).

A common issue with all refrigerant gas sensors (RGS) in this context is false positive readings that may occur as a result of commercial and/or industrial environments such as commercial buildings, hotels, and the like where cleaning agents often falsely trigger conventional RGS and indicate a RGL where in fact no such leak has occurred. The patents incorporated herein provide a methodology to screen RGS readings in order to minimize these false readings of RGL.

The present invention extends this screening function to incorporate measured thermal differential temperatures along various elements within the HVAC system to determine if a refrigerant leak has occurred. These measured thermal differential values (DTV) can be incorporated into a differential temperature matrix (DTM) that describes the thermal state of the HVAC system. The DTM can be compared against a set of predetermined values for a particular HVAC system to determine the presence or absence of a refrigerant leak.

This differential temperature information may be used to directly determine the presence of a refrigerant leak within the HVAC system and/or alternatively qualify or further screen the results of a refrigerant gas leak detector as described within patents incorporated within manner this application. In this a more accurate determination of a refrigerant leak state may be obtained that would normally be available using only a refrigerant gas sensor.

### BRIEF SUMMARY OF THE INVENTION

The present invention pertains to a system and method wherein a HVAC system can be monitored and controlled to detect and mitigate component failures within the HVAC system, including but not limited to refrigerant leaks in the HVAC system.

To accomplish this goal the present invention implements a system and method of comprehensive sensor monitoring including refrigerant gas sensors, refrigerant temperature sensors, refrigerant pressure sensors, ambient temperature sensors, ambient humidity sensors, air flow sensors, flow current sensors, and voltage potential sensors. The system and method operate under control of a digital control processor (DCP) implementing a finite state machine (FSM) and closed-loop monitoring of the sensors placed within the HVAC system. Periodic sensor monitoring combined with min/avg/max historical/baseline data (HBD) and LO/HI limits (LHL) permit the DCP to determine the operational state of individual HVAC components and trigger reports to an alarm status indicator (ASI) in the event of a potential or actual HVAC system component failure. Interaction with a wireless user interface (WUI) and/or a mobile user device (MUD) permit both reporting of HVAC system faults as well as remote control of HVAC operation.

The system/method provide for HVAC shutdown in the event of a component failure that may include deenergizing HVAC relay/contactors (HRC), solid-state-relay (SSR), and/or variable frequency drive (VFD) within the HVAC system and/or closing evaporator refrigerant valves (ERV) and/or condenser refrigerant valves (CRV) to mitigate the loss of refrigerant in the HVAC system in the event of a detected refrigerant leak or indications that refrigerant content is below normal levels in the HVAC system.

### BRIEF DESCRIPTION OF THE DRAWINGS

For a fuller understanding of the advantages provided by the invention, reference should be made to the following detailed description together with the accompanying drawings wherein:

FIG. 1 illustrates a generalized system block diagram depicting a preferred exemplary embodiment of a present invention HVAC monitoring and control system (MCS) using a digital control processor (DCP) operating in a closed control loop (CCL) to control and monitor the state of a HVAC system;

FIG. 2 illustrates a flowchart depicting a preferred invention embodiment of a HVAC monitoring method (HMM);

FIG. 3 illustrates a flowchart depicting a preferred invention embodiment of a HVAC control method (HCM);

FIG. 4 illustrates a flowchart depicting a preferred invention embodiment of a HVAC temperature-based leak detection method (TLD) (1 of 2);

FIG. 5 illustrates a flowchart depicting a preferred invention embodiment of a HVAC temperature-based leak detection method (TLD) (2 of 2);

FIG. 6 illustrates a generalized system block diagram depicting a preferred exemplary embodiment of a present invention refrigerant leak detection system (RLD) incorporating one or more refrigerant temperature sensors (RTS) and refrigerant pressure sensors (RPS) in conjunction with a digital control processor (DCP) operating in a closed control loop (CCL) to monitor the state of a HVAC system for refrigerant leaks;

FIG. 7 illustrates a flowchart depicting a preferred invention embodiment of a Refrigerant Temperature/Pressure (RTP) Leak Detection Method;

FIG. 8 illustrates a typical temperature/humidity measurement application context of the present invention as applied to a heat exchanger in a conventional HVAC system and one or more typical refrigerant gas sensors (RGS) mounted in the frame of a door;

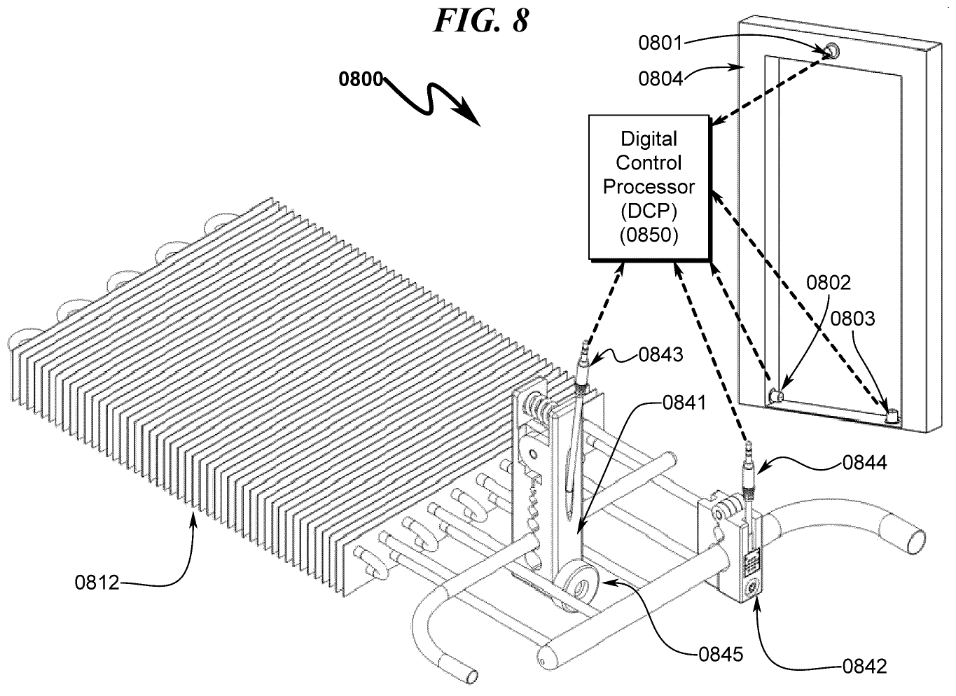

FIG. 9 illustrates a system block diagram depicting a typical HVAC temperature measurement environment (TME);

FIG. 10 illustrates an exemplary temperature sensor bus (TSB) incorporating wired temperature/humidity sensors;

FIG. 11 illustrates an exemplary temperature sensor bus (TSB) incorporating wireless temperature/humidity sensors;

FIG. 12 illustrates an exemplary temperature sensor bus (TSB) incorporating a hybrid of wired and wireless temperature/humidity sensors;

FIG. 13 illustrates a generalized system block diagram depicting a preferred exemplary embodiment of a present invention refrigerant valve configuration featuring evaporator refrigerant valves (1312A, 1312B) and condenser refrigerant valves (1318A, 1318B);

FIG. 14 illustrates a generalized system block diagram depicting a preferred exemplary embodiment of a present invention refrigerant pressure sensor configuration including a variety of refrigerant pressure sensors (1432A, 1432B, 1432C, 1432D, 1432E) located in the overall HVAC refrigerant loop;

FIG. 15 illustrates a generalized system block diagram depicting a preferred exemplary embodiment of a present invention air flow sensor configuration including a variety of air flow sensors (AFS) (1534A, 1534B, 1534C, 1534D) located in the HVAC evaporator environment and the HVAC condenser environment;

FIG. 16 illustrates a flowchart depicting an HVAC Alarm Mode Shutdown Control method useful in some preferred invention embodiments;

FIG. 17 illustrates a system block diagram depicting a HVAC Relay/Contactor (HRC) Coil Current Fault Detection System preferred invention embodiment;

FIG. 18 illustrates a flowchart depicting a HVAC Relay/Contactor (HRC) Coil Current Fault Detection Method preferred invention embodiment;

FIG. 19 illustrates a system block diagram depicting a HVAC Relay/Contactor (HRC) Coil Voltage Fault Detection System preferred invention embodiment;

FIG. 20 illustrates a flowchart depicting a HVAC

Relay/Contactor (HRC) Coil Voltage Fault Detection Method preferred invention embodiment;

FIG. 21 illustrates a system block diagram depicting a HVAC Relay/Contactor (HRC) Contact Current Fault Detection System preferred invention embodiment;

FIG. 22 illustrates a flowchart depicting a HVAC Relay/Contactor (HRC) Contact Current Fault Detection Method preferred invention embodiment;

FIG. 23 illustrates a system block diagram depicting a HVAC Relay/Contactor (HRC) Contact Voltage Fault Detection System preferred invention embodiment;

FIG. 24 illustrates a flowchart depicting a HVAC Relay/Contactor (HRC) Contact Voltage Fault Detection Method preferred invention embodiment;

FIG. 25 illustrates a system block diagram depicting a HVAC Solid-State-Relay (SSR) Contact Current Fault Detection System preferred invention embodiment;

FIG. 26 illustrates a flowchart depicting a HVAC Solid-State-Relay (SSR) Contact Current Fault Detection Method preferred invention embodiment;

FIG. 27 illustrates a system block diagram depicting a HVAC Solid-State-Relay (SSR) Contact Voltage Fault Detection System preferred invention embodiment;

FIG. 28 illustrates a flowchart depicting a HVAC Solid-State-Relay (SSR) Contact Voltage Fault Detection Method preferred invention embodiment;

FIG. 29 illustrates a system block diagram depicting a HVAC Variable Frequency Drive (VFD) Current Fault Detection System preferred invention embodiment;

FIG. 30 illustrates a flowchart depicting a HVAC Variable Frequency Drive (VFD) Current Fault Detection Method preferred invention embodiment;

FIG. 31 illustrates a system block diagram depicting a HVAC Variable Frequency Drive (VFD) Voltage Fault Detection System preferred invention embodiment; and

FIG. 32 illustrates a flowchart depicting a HVAC Variable Frequency Drive (VFD) Voltage Fault Detection Method preferred invention embodiment.

### DESCRIPTION OF THE PRESENTLY PREFERRED EXEMPLARY EMBODIMENTS

While this invention is susceptible of embodiment in many different forms, there is shown in the drawings and will herein be described in detailed preferred embodiment of the invention with the understanding that the present disclosure is to be considered as an exemplification of the principles of the invention and is not intended to limit the broad aspect of the invention to the embodiment illustrated.

The numerous innovative teachings of the present application will be described with particular reference to the presently preferred embodiment, wherein these innovative teachings are advantageously applied to the particular problems of a HVAC MONITORING AND CONTROL SYSTEM AND METHOD. However, it should be understood that this embodiment is only one example of the many advantageous uses of the innovative teachings herein. In general, statements made in the specification of the present application do not necessarily limit any of the various claimed inventions. Moreover, some statements may apply to some inventive features but not to others.

### HVAC Heating/Cooling Operation Not Limitive

The present invention will be described in terms of a conventional HVAC heating/cooling system. In some application contexts, the system is operated solely as a cooling system. Thus, the present invention is not limited to heating, cooling, or heating/cooling systems, but combinations of these configurations are also anticipated.

The present invention may be utilize with heat pumps, heat recovery, refrigeration, and other systems that employ LEV/EEV/TEV/AEV controls and/or REC components. The discussion herein does not limit the type of environment in which the present invention may be applied.

Furthermore, the terms “input port” and “output port” will be referenced to conventional refrigeration systems herein, but it should be understood that these designations will be reversed for heat recovery systems that are also anticipated by the present invention. One skilled in the art will have no trouble in reversing these designations where appropriate in this disclosure to allow the claimed invention to encompass both refrigeration and heat recovery systems.

### Refrigerant Coil Not Limitive

While the present invention has particular application to the detection and mitigation of refrigerant leaks in HVAC evaporator coils, the present invention may equally be applied to HVAC condenser coils. Thus, the term “refrigerant coil” and it synonyms should be given a broad meaning within the scope of this disclosure and the claimed invention.

### Refrigerant Not Limitive

Throughout this document the term “refrigerant” will be used in relation to the detection of any gas/fluid that may be used within a circulating loop in a HVAC system. The present invention may broadly detect a wide range of refrigerant classes in this context, including but not limited to a wide variety of halocarbons that may include traditional refrigerant classes (R11, R12, R113, R114,R115, R22, R123, R134a, R404a, R407C, R410a, etc.) as well as other newer refrigerants (R290, R32, R600, etc.) that may contain hydrocarbons such as butane and/or propane and/or natural gas (NG). Thus, the term “refrigerant” as used herein should be given broad interpretation to cover any of these refrigerant types and others that may be implemented in the future.

With respect to refrigerant types that are combustible, the present invention may be configured to sound alarms notifying occupants that they have a combustible gas leak if a refrigerant leak is detected and the system may be configured to shutoff natural gas (NG) to an indoor furnace if the refrigerant leak is detected, and the level of refrigerant leak in this instance may be reduced to be more sensitive to the detection of natural gas or other combustible refrigerant types.

### Refrigerant Control Valves LEV/EEV/TEV/AEV Not Limitive

The present invention will be discussed in terms of using in some circumstances refrigerant control valves (RCV) to enable/disable refrigerant flow within a HVAC refrigerant loop (HRL). The term refrigerant control valve (RCV) and its variants herein may encompass a wide variety of flow control valves, including but not limited to: linear expansion valve (LEV), electronic expansion valve (EEV), automated expansion valve, solenoid actuated valves, and other types of electrically or mechanically actuated refrigerant valves and metering devices known to those of ordinary skill in the art. Thus, the phrase refrigerant control valves (RCV) and variants should be broadly interpreted within the context of this disclosure.

### LCS/LDT Not Limitive

The present invention will be described in terms of a leak containment system (LCS) (otherwise referred to as a refrigerant leak containment (RLC) or refrigerant leak mitigation (RLM)) in which a leak detection tool (or alternatively as a leak detection troubleshooter) (LDT) or a refrigerant leak detector (RLD)) is used to dynamically monitor ambient refrigerant levels, determine if a refrigerant leak has occurred, pinpoint the location of the leak, and mitigate any adverse effects of the leak by containing the leak to a portion of the HVAC system in which the refrigerant flows.

Thus, the system and method described herein may be used for leak detection and/or leak mitigation and troubleshooting and in some circumstances may be implemented as a leak detection only system/method and in others as a leak detection and mitigation system/method.

### Connection Fitting Type Not Limitive

While the present invention will be described herein using components that utilize soldered connections, the present invention anticipates that other connection fittings may be utilized on the components with no loss of generality in the invention teachings or claim scope.

Specifically, the RFV and EIV described herein may incorporate a wide connection fittings, variety of including but not limited to: soldered; brazed; flared; compression; or national pipe thread (NPT). One skilled in the art will not need additional information to make these substitutions based on specific application context as these connection fittings are standards and well known in the art.

### RFV Orientation Not Limitive

The refrigerant flow valve (RFV) depicted herein is configured with an input transfer port that is configured to be perpendicular to a central transfer port and associated output transfer port. The present invention anticipates that a wide variety of input/central/output port configurations may be utilized with the present invention without loss of generality in the invention teachings or claim scope. One skilled in the art will not need additional information to make these substitutions based on specific application context, as variants of these configurations are well known in the art.

### Condenser Isolation Valve (CIV) Not Limitive

Some preferred exemplary invention embodiments employ a condenser isolation valve (CIV) to isolate refrigerant flow from the output of the refrigerant condenser coil (RCC) to the refrigerant flow valve (RFV). In many preferred embodiments this CIV is implemented as a ball valve having soldered, brazed, flare, or pipe thread (NPT) fittings. In some preferred embodiments this CIV may be a MITSUBISHI ELECTRIC® brand Diamondback BV-FV Series Unibody Design Ball Valve Model selected from a group consisting of: BV14FFSI2; BV28FFSI2; BV12FFSI2; BV58FFSI2; BB14BBSI; BB38BBSI; BB12BBSI; and BB58BBSI. While these CIVs are preferred in many invention embodiments, they are not limitive of the scope of CIV that may be utilized in the present invention.

### Flow Isolation Valve (FIV) Not Limitive

Some preferred exemplary invention embodiments employ a flow isolation valve (FIV) to isolate refrigerant flow from the output of the refrigerant flow valve (RFV) to the refrigerant evaporator coil (REC). In many preferred embodiments this FIV is implemented as a ball valve having soldered, brazed, flare, or pipe thread (NPT) fittings. In some preferred embodiments this FIV may be a MITSUBISHI ELECTRIC® brand Diamondback BV-FV Series Unibody Design Ball Valve Model selected from a group consisting of: BV14FFSI2; BV28FFSI2; BV12FFSI2; BV58FFSI2; BB14BBSI; BB38BBSI; BB12BBSI; and BB58BBSI. While these FIVs are preferred in many invention embodiments, they are not limitive of the scope of FIV that may be utilized in the present invention.

### Evaporator Isolation Valve (EIV) Not Limitive

Some preferred exemplary invention embodiments employ an evaporator isolation valve (EIV) to isolate refrigerant flow from the output of the refrigerant evaporator coil

(REC) to the refrigerant compressor (RFC). In many preferred embodiments this EIV is implemented as a ball valve having soldered, brazed, flare, or pipe thread (NPT) fittings. In some preferred embodiments this EIV may be a MITSUBISHI ELECTRIC® brand Diamondback BV-FV Series Unibody Design Ball Valve Model selected from a group consisting of: BV14FFSI2; BV28FFSI2; BV12FFSI2; BV58FFSI2; BB14BBSI; BB38BBSI; BB12BBSI; and BB58BBSI. While these EIVs are preferred in many invention embodiments, they are not limitive of the scope of EIV that may be utilized in the present invention.

### Isolation Valve Count Not Limitive

While the present invention as discussed herein provides examples of system embodiments wherein a CIV, FIV, and EIV are implemented, the present invention is not limited to these particular configuration and some preferred exemplary system embodiments may have fewer than these three valves or combinations of less than these three valves.

While many of the CIV/FIV/EIV used in implementing the present invention may incorporate one or more Schrader valves (also called an American valve) between the CIV/FIV/EIV refrigerant input port (RIP) and refrigerant output port (ROP) (between which is positioned the refrigerant control valve (RCV) that allows the CIV/FIV/EIV to halt refrigerant flow from the RIP to the ROP) to allow the refrigerant flow lines and/or REC to be evacuated and filled with refrigerant on one or more sides of the CIV/FIV/EIV valve structure, this is not necessarily a requirement of the CIV/FIV/EIV.

The positioning of the Schrader valve in these implementations is preferred to be between the CIV RIP and the RCC output port, the FIV ROP and the REC input port, RIP and the EIV and the output port. This configuration allows isolation of the RFV and/or the REC to affect repair and/or replacement of either of these HVAC system components as well as the AEV. These valves as positioned in the HVAC system allow the REC to be evacuated and filled with refrigerant without impacting the REV or RCC. These valves as positioned in the HVAC system allow the AEV to be replaced and/or repaired without impacting the REV, RCC, or REC.

However, some invention embodiments may place the Schrader valve at different positions within the CIV/FIV/EIV, while other embodiments may utilize two Schrader valves, one between the RIP and the RCV, and another between the ROP and the RCV. While the use of Schrader valves is preferred and these valves are well known in the art, the present invention is not limited to this particular type of valve in the implementation.

Solenoid Cutoff Valves Not Limitive

Many preferred embodiments of the present invention may incorporate electrically actuated solenoid drive refrigerant cutoff valves to isolate one or more components of the HVAC system when a refrigerant leak is detected. While many valve types may be used in this application context, several preferred invention embodiments make use of solenoid cutoff valve model SD-15/52015, available from Parker Hannifin Corporation, Sporlan Division, 206 Lange Drive, Washington, MO 63090 USA, phone 636-239-1111, fax 636-239-9130, www.sporlan.com.

These valves in some circumstances may be substituted with manually activated refrigerant cutoff valves (RCV) such as the FIV/EIV described above that are actuated by an operator in response to alarms provided by the refrigerant leak detector (RLD) described herein.

### Relay/Contractor Not Limitive

Within this document the terms “relay” and “contactor” are both used to refer to electronic or electromechanical switches that are typically activated by a coil/activation voltage and contain one or more electrically or mechanically activated contacts to form a closed circuit. Typically, within the HVAC industry these devices are termed “contactors” and are used to switch fairly large currents from the mains supply to the HVAC compressor, condenser fan, and/or evaporator fan. In some modern HVAC systems these mechanical switch devices are replaced by electronic switches that perform the same function in that they are enabled by a low voltage supply (typically 24 VAC) and switch high current loads running on 100 VAC-660 VAC. Within the context of this document, all of these electrical switching devices will be considered as equivalent in that they may be monitored and controlled by the present invention to detect and mitigate actual, potential, and gradual fault mechanisms within these power control switching units.

The harsh environment in which these devices operate can degrade their performance in a variety of ways. Firstly, the large currents being switched to inductive loads such as compressor motors and fan motors will pit the contacts within the relay/contactor and result in poor connection connectivity, higher-than-normal contact resistance, and subsequent failure of the contactor switch. Secondly, elevated temperatures may result in the insulation of the coil winding of the contactor to fail causing an internal short in the contactor coil. Thirdly, the contacts in the contactor may become contaminated with dust/debris resulting in poor or failing contactor switch contacts. All of these failure mechanisms are not currently detected by the prior art.

Some modern HVAC systems have replaced conventional mechanical HRC elements with solid-state-relays (SSR) that incorporate electronic components to affect high-voltage high-current load switching in response to a low level control signal (LCS). It should be noted that the present invention views mechanical HVAC relay/contactors (HRC) as equivalent to solid-state-relays (SSR) in that they are both configured to receive a low-level control signal (LCS) (typically 24 VAC) and activate a high-voltage, high-current switch (HCS) in response to this control signal. This analogy holds true for the fault detection systems and methods described herein as the same current and/or voltage monitoring techniques may be applied to a SSR as are applied to a HRC, in that the COIL of a HRC may be equated to the LCS and the SWITCH CONTACTS of the HRC may be equated to the HCS of the SSR.

Some modern HVAC systems have replaced conventional mechanical HRC elements with H-bridge transistor logic that allows the switched load to be operated at a variable voltage and/or frequency to permit the rotational speed of the AC load to be modulated. These systems are often termed “variable frequency drive (VFD)” or “inverting switching controls (ISC)” configurations and are completely electronic in construction. It should be noted that the present invention views mechanical HVAC relay/contactors (HRC) as equivalent to VEDs in that they are both configured to activate a high-voltage, high-current source (HCS) in response to HVAC operational controls. This analogy holds true for the fault detection systems and methods described herein as the same current and/or voltage monitoring techniques may be applied to the VFD output as are applied to a HRC, in that the SWITCH CONTACTS of the HRC may be equated to the HCS output of the VFD. In this scenario, the H-bridge of the VFD is internal to the HVAC control system, but output the of this H-bridge is available for current/voltage monitoring by the present invention as it is presented to the HVAC load device.

### Current/Voltage Monitoring Examples

The present invention anticipates that the DCP will utilize a variety of current and/or voltage monitoring sensors within the overall system to both detect and anticipate faults within the HVAC system. An example of this methodology may be applied to the detection of a failed or soon-to-be failing compressor motor relay/contactor, solid-state-relay (SSR), variable frequency drive (VFD), and/or inverting switching controls (ISC) will now be discussed.

The present invention may be configured to monitor the current through the compressor motor relay/contactor coil. This information may be collected and historically saved in Increases in the historical DCP non-volatile memory (NVM). current consumption of the relay/contactor coil may indicate coil winding shorts, or in some cases dirt/debris in the contactor mechanism causing the engagement of the mechanical contactor switch to be sluggish or jammed. If the coil current is drastically reduced or zero, then this might be an indication that the contactor coil has opened, or a safety fuse in the contactor coil has opened due to an unexpected short in the coil. In either case, these conditions indicate a failed or soon-to-be failing relay contactor and the need for a technician to affect service to the HVAC system.

The present invention may be configured to monitor the voltage across the compressor motor relay/contactor contacts to determine if the switch contacts have become pitted. Each of the contactor switch contacts has a finite resistance that will increase with age and pitting of the contacts. If the resistance is too high then the compressor will not operate efficiently and may in some cases burn out the compressor.

The present invention may be configured to monitor the current thru the compressor motor relay/contactor contacts to determine how much current is being consumed by the compressor motor. This information along with historical data may indicate the need for the replacement of the RUN/START capacitor used in conjunction with the compressor motor or other motor such as an evaporator/condenser fan in the HVAC system. Elevated current levels may indicate a failing RUN/START capacitor, a failing compressor or fan motor, or other problems in the HVAC system. Greatly reduced current readings may indicate pitted relay/contactor switch contacts or faulty wiring in the HVAC system.

### Current/Voltage Limits Not Limitive

The present invention will use the symbols “«” and “»” to mean “much less than” and “much greater than” respectively when used as comparisons between current measured current/voltage values and baseline/historical/LimitLO/LimitHI values to determine if fault conditions are detected in the HVAC system.

### Drawings Not to Scale

The drawings presented herein have been scaled in some respects to depict entire system components and their connections in a single page. As a result, the components shown may have relative sizes that differ from that depicted in the exemplary drawings. One skilled in the art will recognize that piping sizes, thread selections, and other component values will be application specific and have no bearing on the scope of the claimed invention.

### Schematics Exemplary

The present invention may be taught to one of ordinary skill in the art via the use of exemplary schematics as depicted herein. One skilled in the art will recognize that these schematics represent only one possible variation of the invention as taught and that their specific connectivity, components, and values are only one possible configuration of the invention. As such, the presented schematics and their associated component values and illustrated voltage levels do not limit the scope of the claimed invention. Additionally, it should be noted that conventional power supply decoupling capacitors are omitted in the presented schematics as they are generally application specific in value and placement.

### Digital Control Processor (DCP) Not Limitive

The implementation of the digital control processor (DCP) described herein may take many forms, including but not limited to discrete digital logic, microcontrollers, finite state machines, and/or mixed analog-digital circuitry. While in many preferred exemplary embodiments the DCP is implemented using an 8051-class (8021, 8041, 89C microcontroller, the present invention is not limited to this particular hardware implementation.

### States/Modes Not Limitive

The present invention will be herein described in terms of CCL STATES in many embodiments. These states may equivalently be described in terms of CCL MODES of operation.

### Time Delays Not Limitive

The present invention may make use of a variety of DCP selected time delays during the operation of the system. The time delays presented herein are only exemplary of those found in some preferred embodiments and are not limitive of the claimed invention. A “selected time delay” will refer to any time delay found appropriate in a particular application context of the present invention.

### Wireless User Interface (WUI) Not Limitive

Some preferred invention embodiments may incorporate a wireless user interface (WUI) allowing control and/or interrogation of the DCP from a mobile user device (MUD) or some other type of networked computer control. The WUI may take many forms, but many preferred invention embodiments utilize a BLUETOOTH® compatible interface to the DCP to accomplish this function.

### Wireless Communication Protocol Not Limitive

Some preferred invention embodiments utilize a wireless user interface (WUI) to allow external communication and/or control of the DCP. In this manner the operational STATE of the CCL can be interrogated, ASI alarms enabled/inhibited, HVAC controls manually operated, and stored information regarding the details of the particular HVAC system stored/retrieved. In many preferred exemplary embodiments the WUI is implemented using a BLUETOOTH® radio transceiver, in frequency and some circumstances a Shenzhen Xintai Micro Technology Co., Ltd. Model JDY-30/JDY-31 BLUETOOTH® SPP Serial Port Transparent Transmission Module or DSD TECH model HM-10/HM-11 (www.dsdtech-global.com) that implement a BLUETOOTH® wireless transceiver using a digital serial port of the DCP. One skilled in the art will recognize that this is just one of many possible WUI implementations.

### Mobile User Device (MUD) Not Limitive

Some preferred invention embodiments may incorporate a mobile user device (MUD) allowing control and/or interrogation of the DCP via a WUI or other computer network. The MUD may take many forms, but many preferred invention embodiments utilize a tablet, smartphone, or other handheld device to wirelessly communicate with the DCP using a WUI. In some circumstances this MUD may utilize telephone or Internet communications to affect this DCP command/interrogation capability.

### Alarm Status Indicator (ASI) Not Limitive

Many preferred invention embodiments may incorporate an alarm status indicator (ASI) comprising one or more light emitting diode (LED) displays (including LED displays utilizing a digital or segmented format) and/or audible alarm indicators. These devices may take many forms, including but not limited to single LED indicators, LED multi-segment displays, and piezo-electric audible indicators. In each of these cases the activation duty cycle and frequency of operation of these displays may be altered to provide indications of alarm status values or to provide information as to the STATE in which the system is operating. The present invention makes no limitation on how these displays operate or in what combination they are combined to provide the ASI functionality.

### Power Supply Not Limitive

The present invention as described in the exemplary embodiments herein makes use of AC power derived from the HVAC system (AC power, typically for use with RLM implementations) or in other circumstances may use battery power (battery power, typically for use with RLD implementations). However, some implementations may utilize ETHERNET or some other wired network that supports power-over-Ethernet) (POE). In these circumstances the wireless user interface (WUI) will encompass a wired communication network (WCN) that provides power to the system. The WUI as described herein encompasses the possibility of the use of a WCN incorporating power-over-Ethernet (POE) as a power source for the system.

In these circumstances the RLD/RLM may be connected directly to maintenance technician or facility manager computers to allow these remote computers to perform HVAC system analysis, generate reports on HVAC systems, refrigerant leak detection, and perform other functions on the RLD/RLM units.

### Temperature/Humidity Sensor (THS) Not Limitive

The term “temperature/humidity sensor (THS)” should be broadly construed to include temperature sensors only, humidity sensors only, and sensors capable of sensing both temperature and humidity. While many preferred invention embodiments may utilize DALLAS SEMICONDUCTOR (MAXIM) DS18B20 (or variant) devices as temperature sensors, the present invention is not limited to these particular devices. While many preferred invention embodiments may utilize GUANGZHOU ASAIR Electronic CO., LTD. Model AGS02MA/DHT20 (or variant) devices as temperature/humidity sensors, the present invention is not limited to these particular devices.

### Temperature Sensors Include Thermistors

Temperature sensors within the context of the present invention also include the use of thermistors. Thermistors are temperature-sensitive resistors, and their resistance changes with temperature. There are two main types of thermistors, each responding differently to temperature changes:
1. NTC (Negative Temperature Coefficient) Thermistors:
   Resistance Characteristics: C thermistors, resistance decreases as the temperature increases. This is because, at higher temperatures, more charge carriers (electrons) become available, reducing resistance.
   Typical Use: NTC thermistors are commonly used in temperature sensing applications, like temperature probes and digital thermometers. They are effective for measuring temperatures in a range of applications, including HVAC systems and medical devices.
2. PTC (Positive Temperature Coefficient) Thermistors:
   Resistance Characteristics: In PTC thermistors, resistance increases as the temperature rises. This occurs due to the reduction of charge carriers at higher temperatures, leading to an increase in resistance.
   Typical Use: PTC thermistors are used in often overcurrent protection, self-regulating heating elements, and circuit protection. They can help prevent excessive current flow in circuits by increasing resistance as the temperature increases.

Within the context of the present invention, the use of thermistors to measure temperature can be accomplished via a voltage sensor communicating with the DCP. Operational states within this temperature measurement configuration typically are of the following types:
Normal Operation: The voltage will be within a specific range based on the thermistor's resistance at certain temperatures.
Open Circuit: If the thermistor is open, the voltage will be equal to the supply voltage (as no current flows through the thermistor).
Short Circuit: If the thermistor is shorted, the voltage will drop to zero (or close to it) since the resistance is negligible.
   The present invention may utilize historical/baseline voltage data (HBV) information stored in the DCP to determine the operational state of thermistors in the overall invention embodiment to detect and report faults in this temperature measurement configuration.

### Historical/Baseline Data (HBD)/LO/HI Limits (LHL) Not Limitive

The present invention incorporates a digital control processor (DCP) and a plurality of operational state sensors (OSS) that collect data on the operational state of a HVAC system using a wide variety of sensor types. The measured operational state (MOS) collected from an individual sensor is stored by the DCP in digital state memory (DSM) in a variety of ways. First, the MOS is stored as current data (CUR) with a time stamp indicating when the measurement was made. Second, it is incorporated into an average MOS data value (AVG) associated with the individual OSS. Thirdly, it is used to update a minimum MOS value (MIN) associated with the individual OSS.

Fourthly, it is used to update a maximum MOS value (MOS) associated with the individual OSS. Fifthly, it is used to update a standard deviation MOS value (DEV) associated with the individual OSS. Sixthly, it is used to update a count of measurements accumulated (CNT) by the DCP for a given OSS.

It should be noted that in many circumstances TWO sets of the above information will be collected and saved. The first set is associated with the HVAC system in an operational state and is termed the RUN parameter set. The second set s associated with the HVAC system in a non-operational state and is termed the IDL parameter set. By collecting both of sets information an accurate historical/baseline can be set for the two modes of HVAC operation and in some circumstances the HVAC system can be prevented from activating in situations where a fault is detected before the HVAC system is started.

This information is available for inspection and/or reset via the wireless user interface (WUI) and/or mobile user device (MUD). Various methods taught by the present invention may use this CUR/MIN/AVG/MAX/DEV/CNT data to determine if a given MOS from the OSS indicates a fault within the HVAC system that will trigger an ASI and/or fault message to the WUI/MUD.

The DSM may also provide for storage of LimitLO and LimitHI range limiting data for each operational mode (RUN/IDL) that can be used to detect faults within the HVAC system by setting hard bounds that if exceeded by the MOS will trigger the indication of a HVAC fault in the associated OSS measurement and activation of an alarm status indicator (ASI) and/or fault message to the WUI/MUD.

### THS Placement Not Limitive

While the present invention depicts the THS as being placed in thermal contact with various HVAC elements, the placement of the individual THS is not limited to the HVAC system but can include other environmental locations not specifically associated with the HVAC system. This could include air fans, air plenums, intake/exhaust grates/ports, ambient indoor/outdoor temperatures, and other locations that may be used to characterize the state of the operational HVAC system.

### RGS Placement Not Limitive

In some preferred invention embodiments the THS is utilized with a refrigerant gas sensor (RGS) to determine if a refrigerant gas leak (RGL) has occurred. While the RGS sensor(s) may be placed anywhere within the HVAC system air flow, many preferred invention embodiments utilize RGS sensors located within the frame of a door in order to detect RGL conditions.

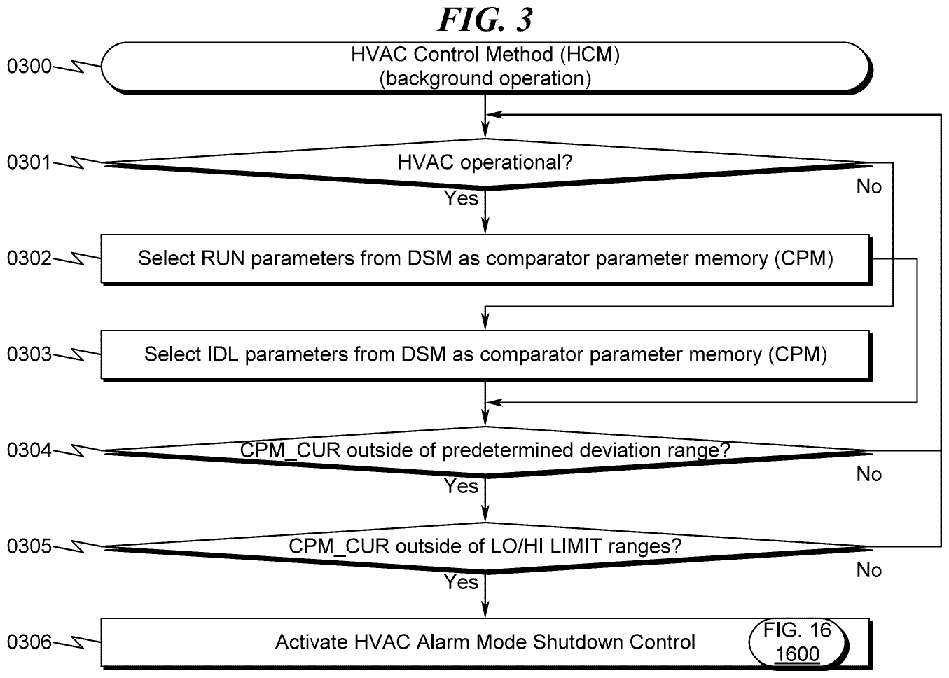

Specifically, and without limitation, many preferred invention embodiments will place the RGS in the lower portion of the door frame proximal to the bottom edges of the door frame such that air flow that occurs under the lower edge of the door will pass by the RGS. This placement can occur at the bottom horizontal surface of the door frame as well as on the vertical surfaces of the door frame just above the bottom edge of the door frame but below the edge of door as mounted within the door frame. Since RGL conditions emit refrigerant gas that is typically heavier than ambient air, the placement of the RGS in the lower portion of the door frame will optimize the detection of the RGL in many environments such as hotel rooms and other commercial facilities. An example of this placement is generally depicted in FIG. 3 (0300).

### Differential Temperature Matrix (DTM) Not Limitive

In various preferred invention embodiments a differential temperature matrix (DTM) is maintained by the DCP and incorporates baseline temperature measurements at various points in the HVAC refrigerant loop as well as ambient temperature readings and/or readings directly attributable to various components in the HVAC system (condenser, compressor, evaporator) as well as input/output connections and connecting refrigerant lines to these various components.

This DCP is generally a square matrix and has a matrix order that is dependent on the particular implementation of the disclosed invention. Some embodiments may utilize a few temperature readings sensor in order to qualify/identify refrigerant leaks and therefore have a low matrix order. Other more advanced value DTM implementations will incorporate numerous THM that may be located anywhere within the HVAC system and thus this implementation will have a higher order DTM matrix order. It is envisioned that the minimum DTM matrix order will be unity (1) in the most basic invention embodiments.

Further to the above, it should be noted that while the diagonal elements of the DTM will generally record absolute temperature measurements from the various THS, the off-diagonal components of the DTM need not always be calculated or populated with differential temperature data. Thus, the DTM may be configured to measure absolute temperatures but not use these in differential temperature measurements in the DTM.

In many configurations the DTM off-diagonal elements will contain differential temperature measurements associated with differences in temperature between various on-diagonal elements of the DTM. For example, the on-diagonal DTM elements may contain absolute temperature measurements for the compressor inlet and compressor exhaust, while the off-diagonal DTM elements may contain a differential temperature between these two values as well as additional humidity information that may be used to determine the efficiency of the HVAC refrigerant cycle.

Finally, the DTM may incorporate calculated values in some of its matrix elements, such as dew point, or other values that are calculated from MTV data. This information may be utilized to determine, for example, how hard the HVAC system is working to achieve a desired temperature/humidity set point within a given controlled environment. This information can then be used to indirectly determine whether a refrigerant leak has occurred. For example, if the measured/calculated values indicate that the desired set point has not been reached, temperature values within the system have exceeded predetermined values, and the HVAC system is operating to capacity with a duty cycle exceeding a predetermined percentage, then this may indicate a refrigerant leak or other system malfunction that should be immediately addressed.

### Generalized Refrigerant Gas Leak (RGL) Detection Methodology

The present invention utilizes absolute measured temperature value (MTV) and/or differential temperature value (DTV) measurements to determine a potential and/or actual refrigerant gas leak (RGL) with a given HVAC system. While there are many possible implementations of this methodology, two will be presented here as examples.

As a first example, an absolute discharge temperature on a compressor above 220 degrees Fahrenheit will generally indicate a refrigerant under-charge or refrigerant gas leak (RGL) within the HVAC system. While various HVAC systems will vary with respect to this ALARM trip value, this value is a good starting point for most HVAC systems.

As a second example, a differential between the return air temperature (RAT) and blower supplier temperature (BST) should be between 15 to 20 degrees Fahrenheit with any DTV below 10 degrees indicating a refrigerant under-charge or refrigerant gas leak (RGL) within the HVAC system. This may warrant an alarm indicating that maintenance of the HVAC system is warranted. In these and other circumstances, the DCP may opt to issue an ASI alarm but not shutdown the HVAC system, as only an indication of HVAC maintenance is indicated by the fault or potential fault conditions.

One skilled in the art will no doubt observe that these examples may form the basis of a plurality of other MTV/DTV tests on a formulated DTM to allow the DCP to detect a variety of refrigerant leak conditions within a given HVAC system.

### HVAC Monitoring and Control System Overview (0100)

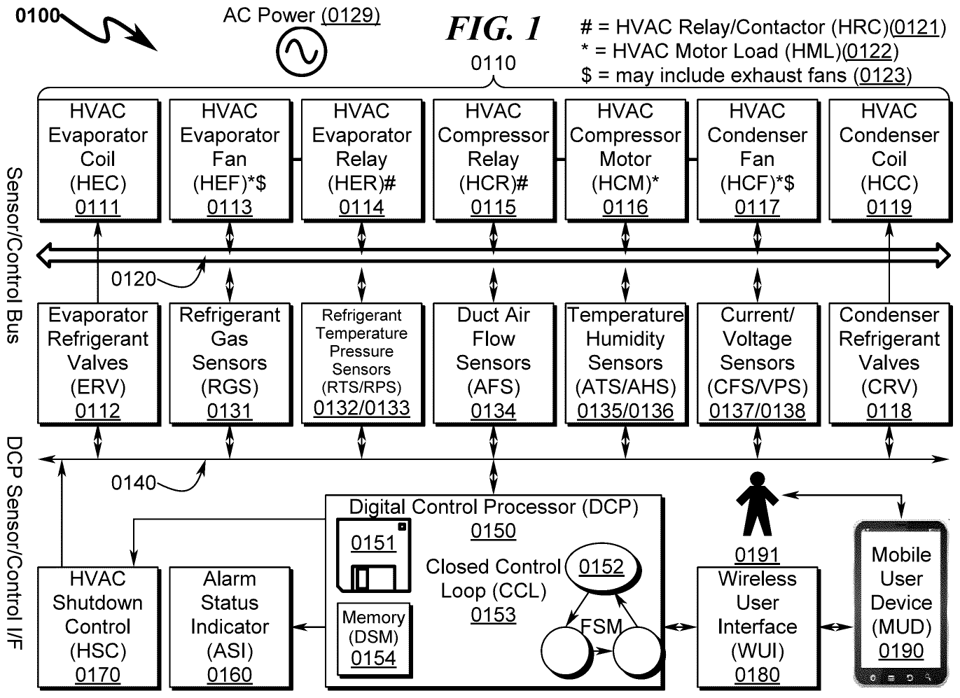

The present invention HVAC monitoring and control system (MCS) in its simplest form is generally depicted in FIG. 1 (0100) as applied to a HVAC system (0110) that comprises evaporator elements (evaporator coil (HEC) (0111), refrigerant evaporator valves (EFV) (0112), evaporator fan (HEF) (0113), evaporator relay (HER) (0114)) and condenser elements (condenser coil (HCC) (0119), condenser refrigerant valves (CRV) (0118), condenser fan (HCF) (0117), compressor motor (HCM) (0116), compressor relay (HCR) (0116)).

This HVAC system (0110) is monitored by a number of operational state sensors (OSS) that may be tied to a sensor/control bus (0120). The OSS may comprise refrigerant gas sensors (RGS) (0131), refrigerant temperature sensors (RTS) (0132), refrigerant pressure sensors (RPS) (0133), duct air flow sensors (AFS) (0134), ambient temperature sensors (ATS) (0135), ambient humidity sensors (AHS) (0136), current flow sensors (CFS) (0137), and voltage potential sensors (VPS) (0138). In a typical invention embodiment there are numerous types of OSS placed throughout the HVAC system and there are also numerous numbers of each OSS type used in the HVAC system to obtain a comprehensive view of the measured operational state (MOS) of the HVAC system both currently and in view of historical/baseline data (HBD) stored in digital state memory (DSM).

The OSS communicate via one or more hardware interfaces (0140) to a digital control processor (DCP) (0150) that collects measured operational state (MOS) data from each individual OSS. The DCP (0150) executes machine instructions from a tangible computer readable medium (0151) that implement a finite state machine (FSM) (0152) operating a closed control loop (CCL) (0153). The CCL (0153) operates to continuously monitor the OSS to obtain a MOS of the HVAC system and interacts with a digital state memory (DSM) (0154) to store current MOS data as historical information but also compare current MOS data to previously stored data and/or LO/HI LIMIT data stored in the DSM to determine if a fault or potential fault has been detected in the HVAC system.

If a fault or potential fault has been detected in the HVAC system, the DCP triggers an alarm status indicator (ASI) (0160) to provide information on the fault condition and may optionally activate a HVAC shutdown control (HSC) (0170) that safely terminates operation of the HVAC system to avoid further damage to HVAC system components and/or to mitigate the loss of refrigerant in the HVAC system.

Activation of the ASI (0160) may also trigger fault error messages to be transmitted by the DCP to a wireless user interface (WUI) (0180) and/or a mobile user device (MUD) (0190) that interacts with a technician (0191) or other service/maintenance personnel.

### HVAC Monitor Method (HMM) (0200)

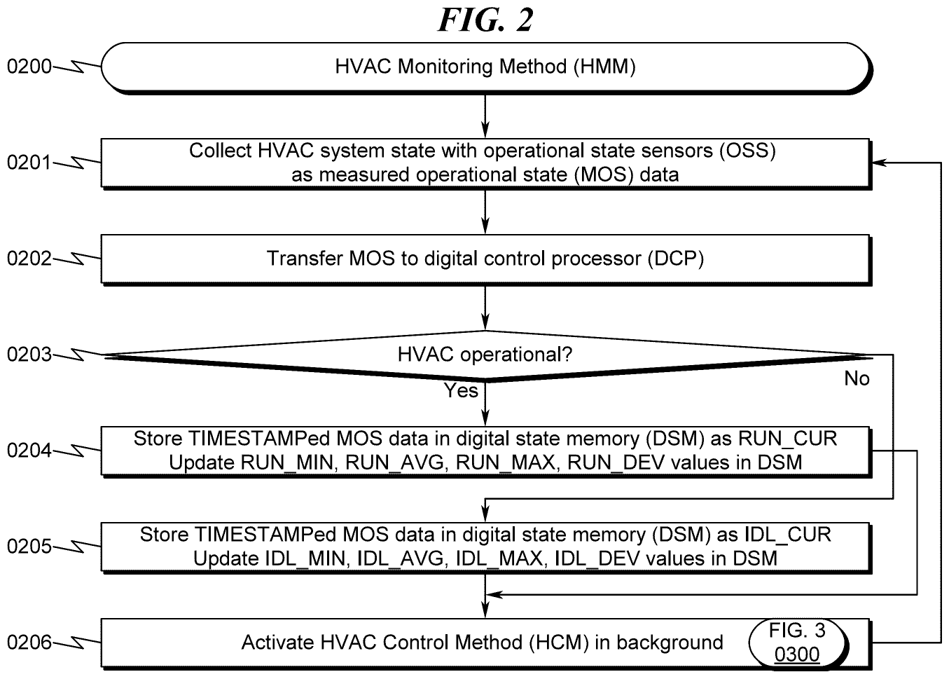

The system block diagram of FIG. 1 (0100) may be associated with a monitoring method depicted in FIG. 2 (0200). As generally depicted in FIG. 2 (0200), the present invention anticipates a HVAC Monitoring Method (HMM) comprising the following steps:
(1) collecting HVAC system state information with operational state sensors (OSS) as measured operational state (MOS) data (0201);
(2) with the DCP, transferring MOS data to digital control processor (DCP) digital state memory (DSM) (0202);
(3) with the DCP, determining if the HVAC system is operational, and if not, proceeding to step (5) (0203);
(4) with the DCP, storing TIMESTAMPed MOS data in digital state memory (DSM) as RUN_CUR and updating RUN_MIN, RUN_AVG, RUN_MAX, RUN_DEV values in DSM and proceeding to step (6) (0204);
(5) with the DCP, storing TIMESTAMPed MOS data in digital state memory (DSM) as IDL CUR and updating IDL_MIN, IDL_AVG, IDL_MAX, IDL_DEV values in DSM (0205); and
(6) with the DCP, activating a HVAC Control Method (HCM) in background and proceeding to step (1) (0206);
   This general method may be modified heavily depending on a number of factors, with rearrangement and/or addition/deletion of steps anticipated by the scope of the present invention without departing from the teachings of the present invention. Integration of this and other preferred exemplary embodiment methods in conjunction with a variety of preferred exemplary embodiment systems described herein is anticipated by the overall scope of the present invention.

### HVAC Control Method (HCM) (0300)

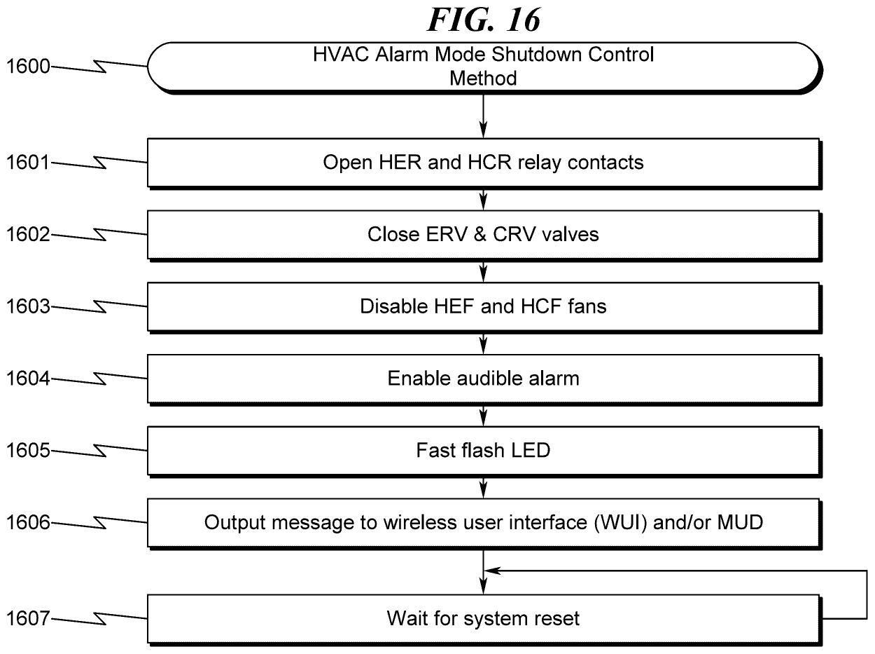

The system block diagram of FIG. 1 (0100) may be associated with a monitoring method depicted in FIG. 3 (0300). As generally depicted in FIG. 3 (0300), the present invention anticipates a HVAC Monitoring Method (HMM) comprising the following steps:
(1) with the DCP, determining if the HVAC system is operational, and if not, proceeding to step (3) (0301);
(2) with the DCP, selecting RUN parameters from DSM as comparator parameter memory (CPM) and proceeding to step (4) (0302);
(3) with the DCP, select IDL parameters from DSM as comparator parameter memory (CPM) (0303);
(4) with the DCP, determining if CPM CUR is outside of predetermined deviation range, and if not proceeding to step (1) (0304);
(5) with the DCP, determining if CPM CUR is outside of LO/HI LIMIT ranges stored in the DSM, and if not, proceeding to step (1) (0305); and
(6) with the DCP, activating a HVAC Alarm Mode Shutdown Control process as generally depicted in FIG. 16 (1600) (0306).
   This general method may be modified heavily depending on a number of factors, with rearrangement and/or addition/deletion of steps anticipated by the scope of the present invention without departing from the teachings of the present invention. Integration of this and other preferred exemplary embodiment methods in conjunction with a variety of preferred exemplary embodiment systems described herein is anticipated by the overall scope of the present invention.

While this HCM is shown as implemented as a background process, it may be integrated within the control loop structure of FIG. 2 (0200) and processed sequentially every time the Oss is polled to extract MOS information regarding the operational state of the HVAC system.

### HVAC Temperature-Based Leak Detection (TLD) Method (0400)-(0500)

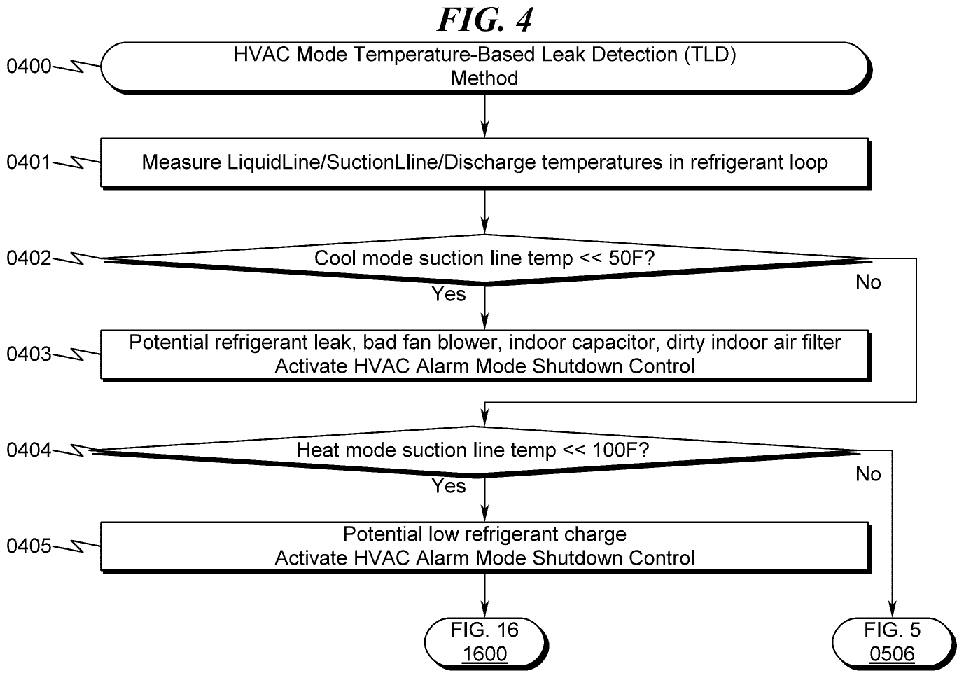

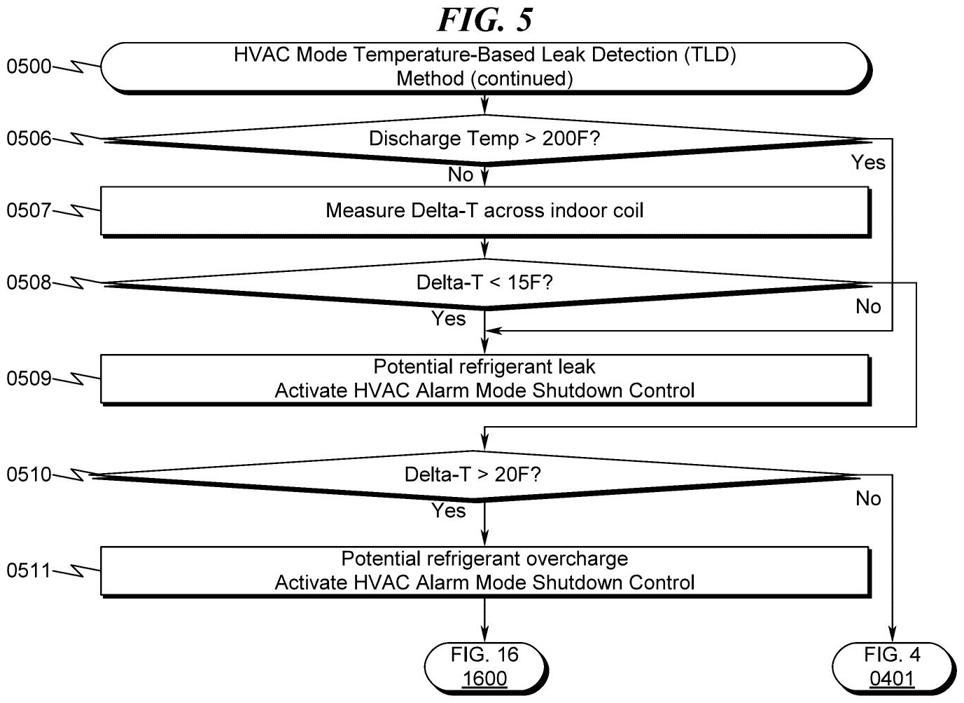

The present invention in some embodiments teaches a temperature-based refrigerant leak detection method as generally depicted in FIG. 4 (0400)-FIG. 5 (0500) wherein refrigerant liquid line, suction line, and discharge temperatures are measured in conjunction with indoor coil input/output temperatures to determine if one or more fault conditions are present in the HVAC system. As generally depicted in FIG. 4 (0400)-FIG. 5 (0500), the present invention anticipates a Temperature-Based Leak Detection (TLD) Method comprising the following steps:
(1) with the DCP, measuring LiquidLine/SuctionLine/Discharge temperatures in the HVAC refrigerant loop using one or more operational state sensors (OSS) (0401);
(2) with the DCP, determining if the cool mode SuctionLine temperature is «50 F, and if not, proceeding to step (4) (0402);
(3) with the DCP, indicating a potential refrigerant leak, bad fan blower, indoor capacitor, dirty indoor air filter and activating a HVAC Alarm Mode Shutdown Control process as generally depicted in FIG. 16 (1600) (0403);
(4) with the DCP, determining if heat mode SuctionLine temperature «100 F, and if not, proceeding to step (6) (0404);
(5) with the DCP, indicating potential low refrigerant charge and activating a HVAC Alarm Mode Shutdown Control process as generally depicted in FIG. 16 (1600) (0405);
(6) with the DCP, determining if the Discharge temperature is >200 F, and if so, proceeding to step (9) (0506);
(7) with the DCP, measuring Delta-T temperatures across the indoor HVAC coil (0507);
(8) with the DCP, determining if Delta-T <15F, and if not, proceeding to step (10) (0508);
(9) with the DCP, indicating a potential refrigerant leak and activating a HVAC Alarm Mode Shutdown Control process as generally depicted in FIG. 16 (1600) (0509);
(10) with the DCP, determining if Delta-T >20 F, and if not, proceeding to step (1) (0510); and
(11) with the DCP, indicating a potential refrigerant overcharge and activating a HVAC Alarm Mode Shutdown Control process as generally depicted in FIG. 16 (1600) (0511).

This general method may be modified heavily depending on a number of factors, with rearrangement and/or addition/deletion of steps anticipated by the scope of the present invention without departing from the teachings of the present invention. Integration of this and other preferred exemplary embodiment methods in conjunction with a variety of preferred exemplary embodiment systems described herein is anticipated by the overall scope of the present invention.

### Temperature/Pressure-Based Leak Detection (TPD) System Overview (0600)

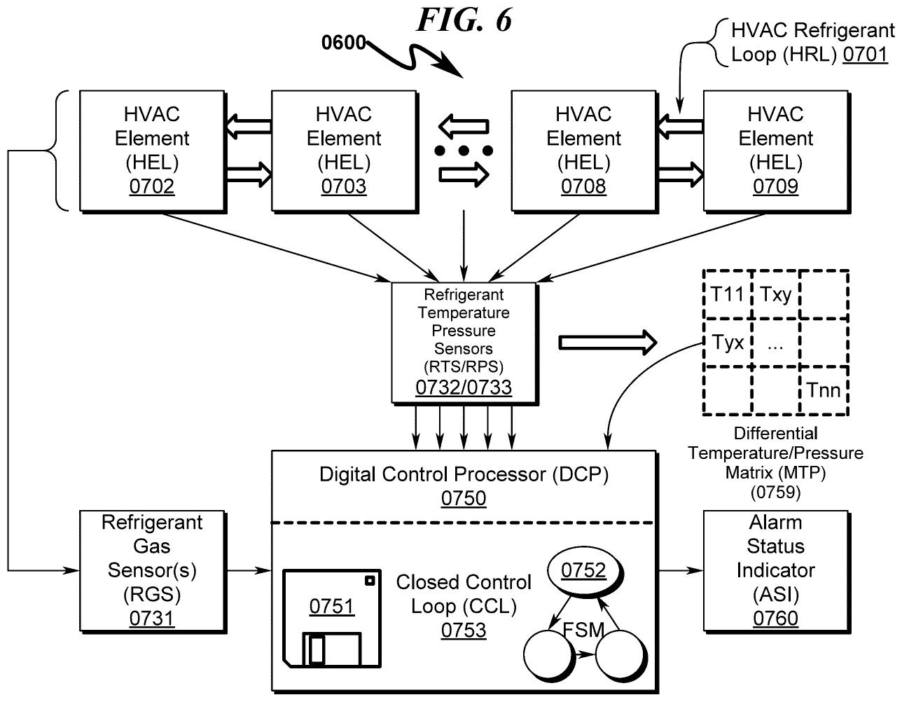

The present invention may be configured as a refrigerant temperature/pressure based leak detection (TPD) refrigerant leak detection (RLD) system in its simplest form as generally depicted in FIG. 6 (0600) as applied to a HVAC system that comprises a HVAC refrigerant loop (HRL) (0601) including one or more HVAC elements (0602, 0603, 0608, 0609) and/or environmental locations in which one or more refrigerant temperature sensors (RTS) (0632) and/or refrigerant temperature sensors (RPS) (0633) are located to collect refrigerant temperature/pressure information on the HVAC element (0602, 0603, 0608, 0609) and/or environmental locations. This collected differential temperature/pressure value information (DTP) is transmitted to a digital control processor (DCP) (0650). The DCP (0650) executes instructions read from a computer readable medium (0651) which implement a finite state machine (FSM) (0652) that form a closed control loop (CCL) (0653). The DCP (0650) transforms the DTP into a differential temperature/pressure matrix (MTP) (0659) that incorporates absolute measured temperatures/pressures as well as differential temperatures/pressures between the various HVAC elements (0602, 0603, 0608, 0609) and/or environmental locations. Historical temperature/pressure data may also be stored in the MTP (0659) and used as a guide to determine if the HVAC refrigerant loop (0601) or one of its elements (0602, 0603, 0608, 0609) is potentially failing or degrading over time.

It should be noted that in all the examples provided herein describing temperature/pressure data, voltage data may also be included in this description, as many of the temperature/pressure sensors are voltage sensing and there may also be a need to measure other voltages within the HVAC system in an attempt to isolate the particular fault that a HVAC system is experiencing.

The MTP (0637) is then compared against predetermined values for a given HVAC configuration by the DCP to absolute and/or differential determine if temperatures/pressures are out of predetermined ranges, and if so, signaling an alarm status indicator (ASI) (0660) that indicates the presence of a refrigerant leak. In some preferred modes of operation, the MTP (0659) is the only data required to determine a refrigerant leak within the HVAC refrigerant loop (0601).

In some other preferred embodiments, the MTP (0659) is used in conjunction with one or more refrigerant gas sensors (RGS) (0631) such that the ASI (0660) is triggered only if the RGS (0631) indicates a refrigerant gas leak (RGL), only if the MTP (0659) indicates a RGL, or only if both the RGS (0631) and the MTP (0659) indicate a RGL. In this manner the RGS (0631) and MTP (0659) can be used to qualify/validate the results of the other sensor in some circumstances where the air surrounding the RGS (0631) may be contaminated with hydrocarbons that are not refrigerant gas but nonetheless indicate refrigerant gas on the RGS (0631) sensor. This condition can often occur in hotels and other environments where cleaning solutions are frequently used during daily housekeeping and/or cleaning operations.

### Temperature/Pressure-Based Leak Detection (TPD) Method Overview (0700)

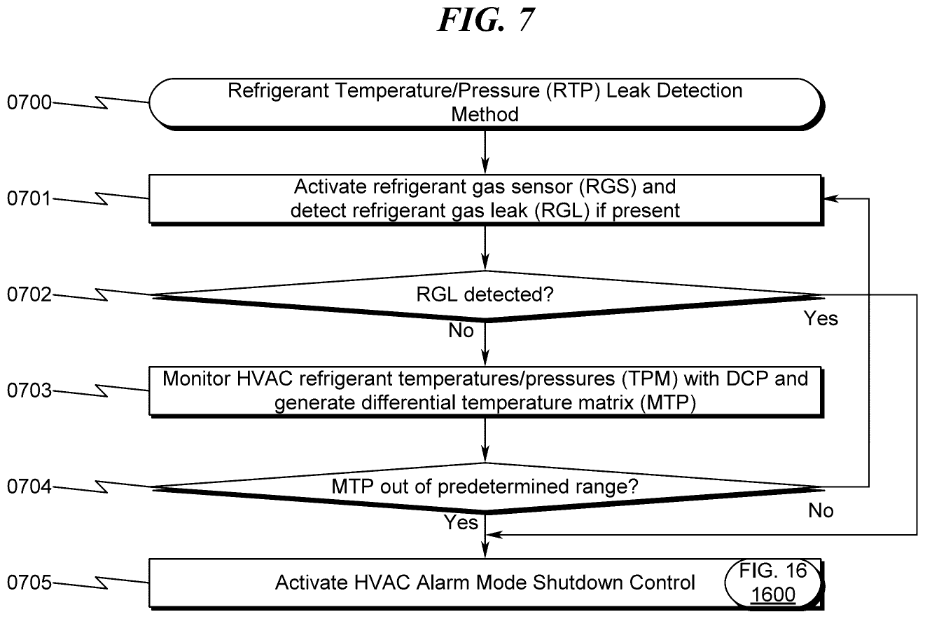

The system block diagram of FIG. 6 (0600) may be associated with a method depicted in FIG. 7 (0700). As generally depicted in FIG. 3 (0300), the present invention anticipates a HVAC Monitoring Method (HMM) comprising the following steps:
(1) with the DCP, activating a refrigerant gas sensor (RGS) and detecting a refrigerant gas leak (RGL) if present (0701);
(2) with the DCP, determining if a refrigerant gas leak (RGL) is detected, and if so, proceeding to step (5) (0702);
(3) with the DCP, monitoring HVAC refrigerant temperatures/pressures (TPM) and generating a differential temperature matrix (MTP) (0703);
(4) with the DCP, determining if the MTP is out of a predetermined range, and if not, proceeding to step (1) (0704); and
(5) with the DCP, activating a HVAC Alarm Mode Shutdown Control process as generally depicted in FIG. 16 (1600) (0706).

This general method may be modified heavily depending on a number of factors, with rearrangement and/or addition/deletion of steps anticipated by the scope of the present invention without departing from the teachings of the present invention. Integration of this and other preferred exemplary embodiment methods in conjunction with a variety of preferred exemplary embodiment systems described herein is anticipated by the overall scope of the present invention.

### Temperature/Humidity Measurement Context (0800)

The THS sensors used by the DCP within the present invention to detect refrigerant leaks may be placed in a wide variety of locations within a HVAC system. FIG. 3 (0800) illustrates a typical HVAC heat exchanger (0812) incorporating the application of a preferred embodiment of TCC/TCS thermal clamps (0841, 0842) and associated THS sensors (0843, 0844) also showing an optional TCC/TCS attachment magnet (0845) configuration. One skilled in the art will recognize from the teachings herein that this is only one of many possible methodologies to provide THS data for the DCP to determine whether a refrigerant leak has occurred.

This diagram also depicts the DCP (0830) in communication with the THS sensors (0843, 0844) and one or more typically mounted refrigerant gas sensors (RGS) (0801, 0802, 0803) that are in this particular example mounted in the frame of a door (0804). This particular application context may be used in some circumstances where detection of the refrigerant gas as in the case of hotel rooms and the like is desired.

### Temperature Measurement Environment (TME) (0900)

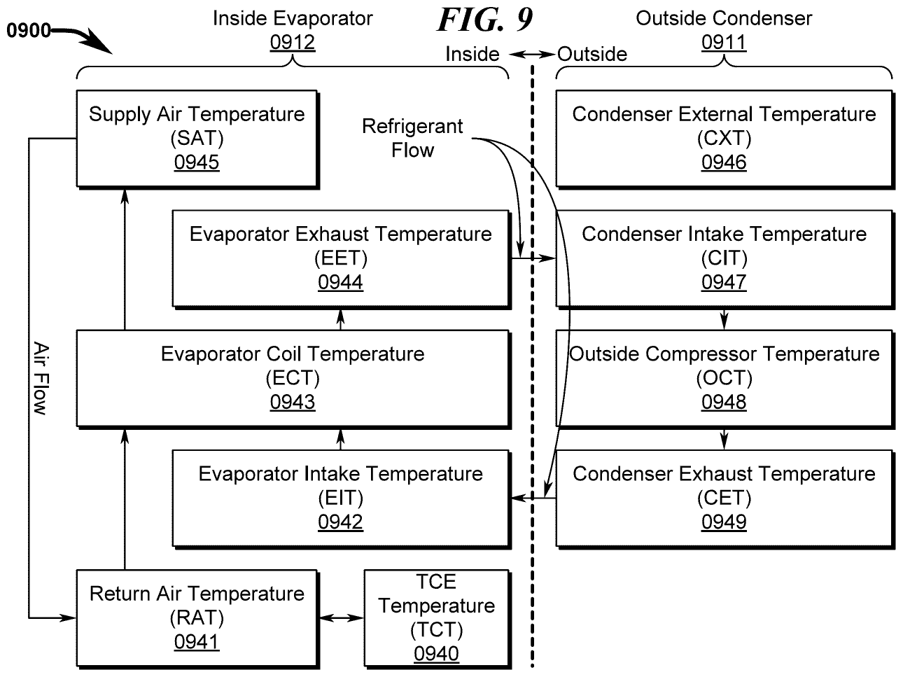

The present invention may be implemented in many forms, but a preferred exemplary embodiment is generally depicted in FIG. 9 (0900) wherein a HVAC system is depicted incorporating an outdoor condenser (0911) and inside evaporator (0912) which form a HVAC refrigerant loop (HRL). In this depicted invention embodiment, temperature sensors (THS) are depicted that monitor the temperature controlled environment (TCE) (0940), return air temperature (RAT) (0941), evaporator intake temperature (EIT) (0942), evaporator coil temperature (ECT) (0943), evaporator exhaust temperature (EET) (0944), and supply air temperature (SAT) (0945) within the inside evaporator (0912). The outside condenser (0911) portion of the HRL is monitored by THS comprising a condenser external temperature (CXT) (0946), condenser intake temperature (CIT) (0947), outside compressor temperature (OCT) (0948), and condenser exhaust temperature (CET) (0949) temperature sensors.

The TCT (0940) and CXT (0946) may be used to determine a range of acceptable operating conditions for the compressor, condenser coils, and evaporator coils. For example, if the measured CXT (0946) temperature is very high, the efficiency of the HVAC system in AC mode may be degraded.

Compressor operation may be monitored by inspecting the CXT (0946) as well as the OCT (0948) to determine if the absolute temperature values or temperature differential is outside a predetermined range that would adversely impact the operation of the compressor long-term. For example, extended operation at over-temp conditions can significantly decrease compressor reliability and should be avoided. These over-temperature conditions may indicate a loss of refrigerant or other system-wide abnormalities that require repair or maintenance.

### Temperature Sensor Bus (TSB) (1000)-(1200)

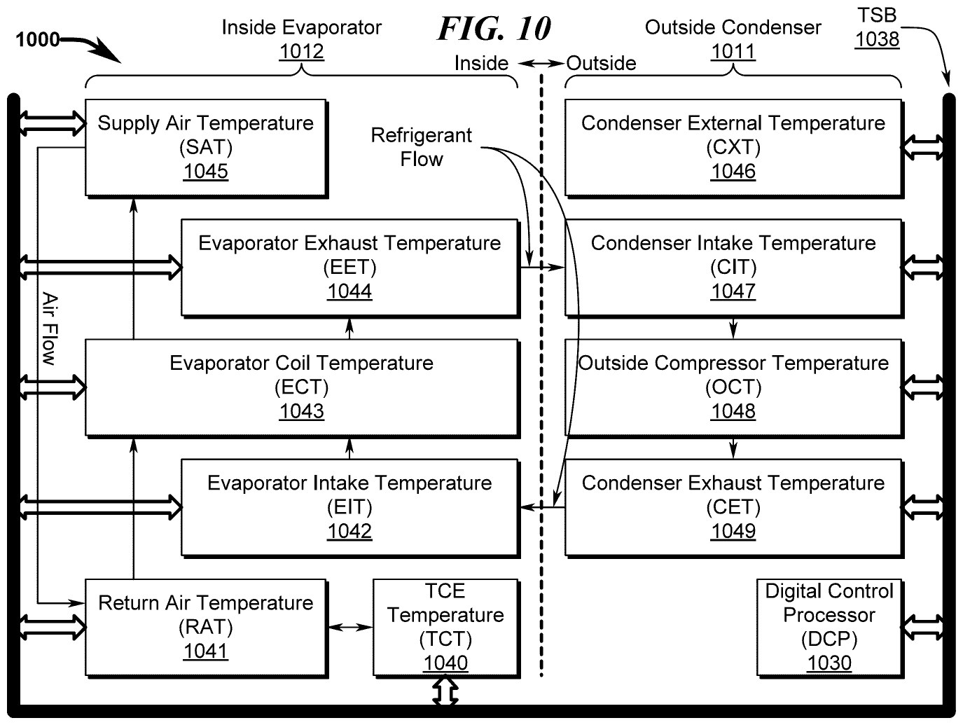

As generally depicted in FIG. 10 (1000), the present invention may collect data from the various THS via the use of a temperature sensor bus (TSB) (1038) that is typically a serial 1-wire data bus that interconnects the various THS such as DALLAS MODEL SEMICONDUCTOR DS18B20 temperature sensors or other temperature/humidity sensors. The TSB (1038) may directly interface to the DCP (1030) or in some circumstances be indirectly coupled to the DCP (1030) via wired or wireless communication.

While some preferred invention embodiments may utilize a serial 1-wire TSB, other invention embodiments may opt for a daisy-chained serial bus, two-wire I2C bus, or other commercially available serial communication methodology to communicate with temperature and/or pressure sensors. Yet other invention embodiments may opt for direct communication between the DCP and each individual OSS.

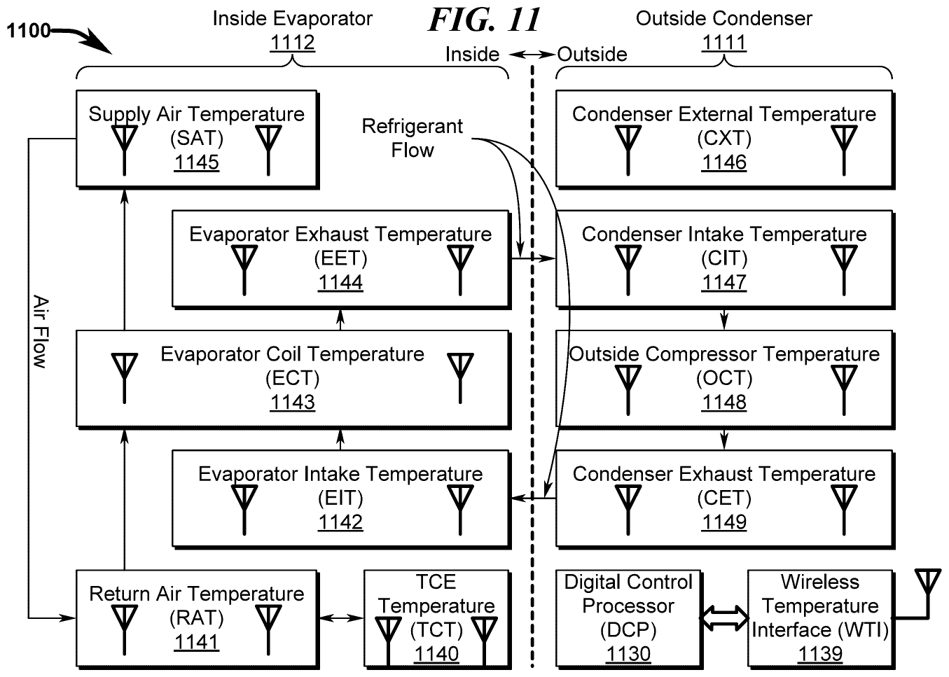

FIG. 11 (1100) depicts a preferred embodiment wherein the communication between the various THS to the DCP is accomplished using a wireless temperature interface (WTI) (1139) in which each of the THS is configured with a separate wireless transmitter. This configuration allows easy retrofit into scenarios where the different temperature measurement points are spatially diverse.

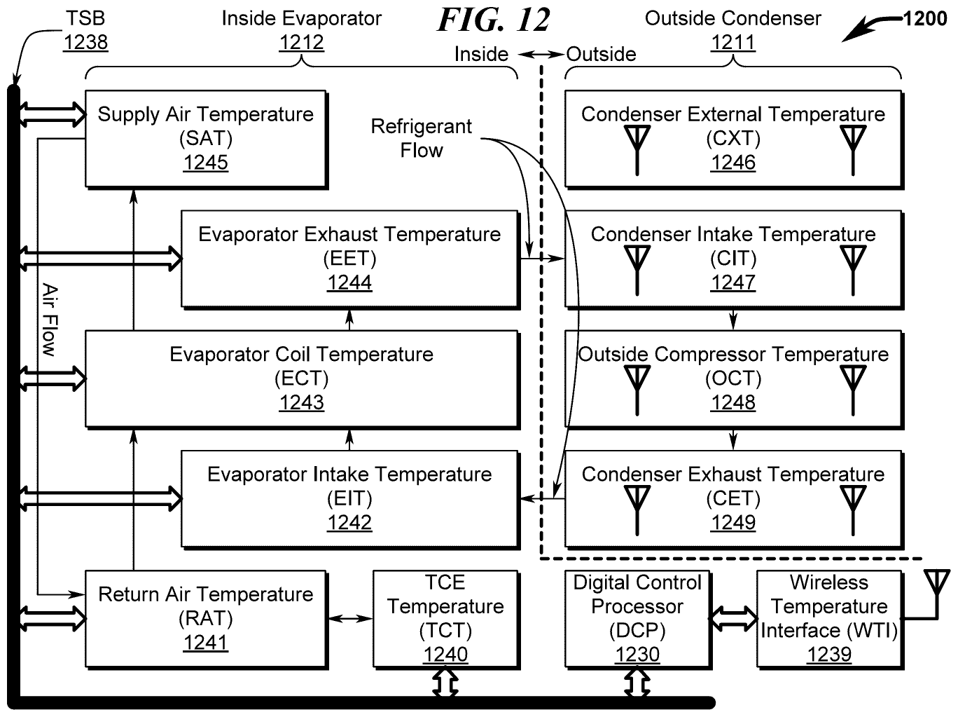

FIG. 12 (1200) depicts another preferred embodiment wherein a hybrid communication system is configured to allow a wired serial bus (1238) to be used within the building structure but a wireless interface (1239) to be used on the outside of the building with respect to the compressor portion of the HVAC system.

The present invention anticipates that in some circumstances a hybrid communication methodology may be utilized for the THS-to-DCP communication wherein one or more of the is THS outfitted with a wireless transmitter/transceiver that communicates with the DCP. Various THS may be tied together with a 1-wire serial bus and then this bus may be interfaced with a wireless transmitter/transceiver to communicate this temperature/humidity information to the DCP. Within this context, it is anticipated that the DCP may be configured with a THS enumeration algorithm to uniquely identify each THS and associated this unique identification with a particular physical position within the overall HVAC system (such as the TCT, RAT, EIT, ECT, EET, SAT, CXT, CIT, OCT, CET, or other physical location within the HVAC system).

### Exemplary Refrigerant Valve Configuration (1300)

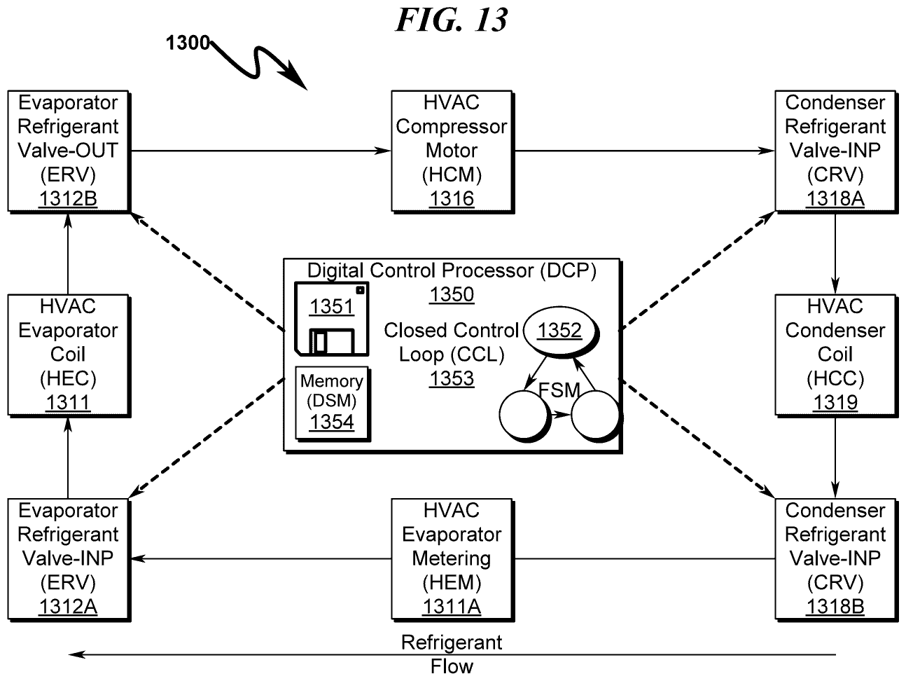

As generally depicted in FIG. 13 (1300), the present invention may incorporate a number of refrigerant valves including evaporator refrigerant valves (1312A, 1312B) and/or condenser refrigerant valves (1318A, 1318B) that are under control of the DCP (1350) to allow the refrigerant flow in the HVAC system to be contained to the evaporator (1311) and/or condenser (1319) in the event of a detected refrigerant leak or other detected or degraded HVAC system component or fault condition.

### Exemplary Refrigerant Pressure Sensor Configuration (1900)

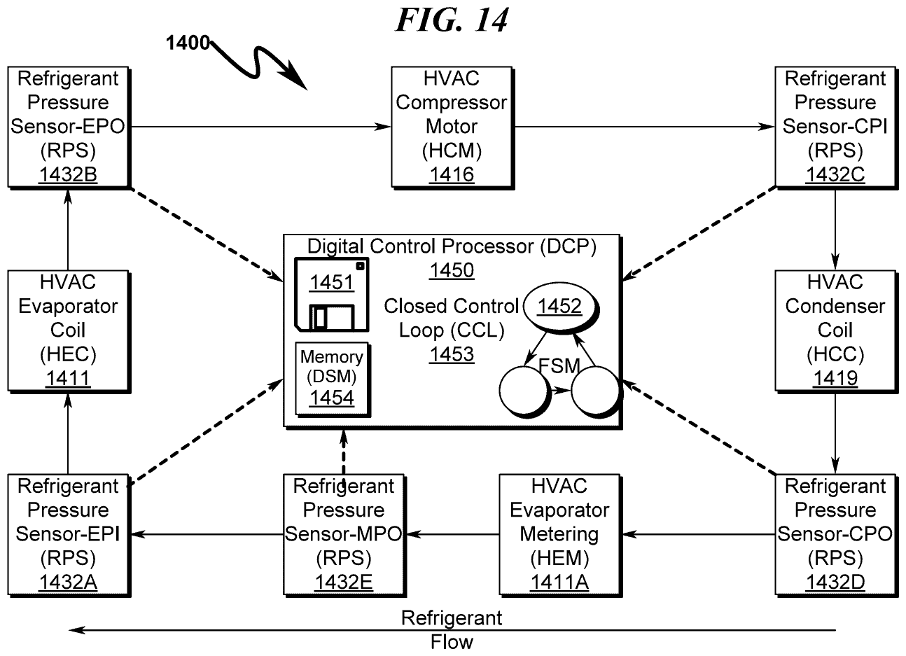

As generally depicted in FIG. 14 (1400), the present invention may incorporate a number of refrigerant pressure sensors (RPS) (1432A, 1432B, 1432C, 1432D, 1432E) that are under control of the DCP (1450) to allow monitoring of refrigerant pressures within the HVAC system with respect to the overall refrigerant flow in the HVAC system. This pressure monitoring with respect to the evaporator (1411) and/or condenser (1419) permits the detection of refrigerant leaks in the system or fault conditions such as overcharge, undercharge, and failures of the HVAC evaporator metering (HEM) (1411A) component in the HVAC refrigerant loop.

### Exemplary Air Flow Sensor Configuration (1500)

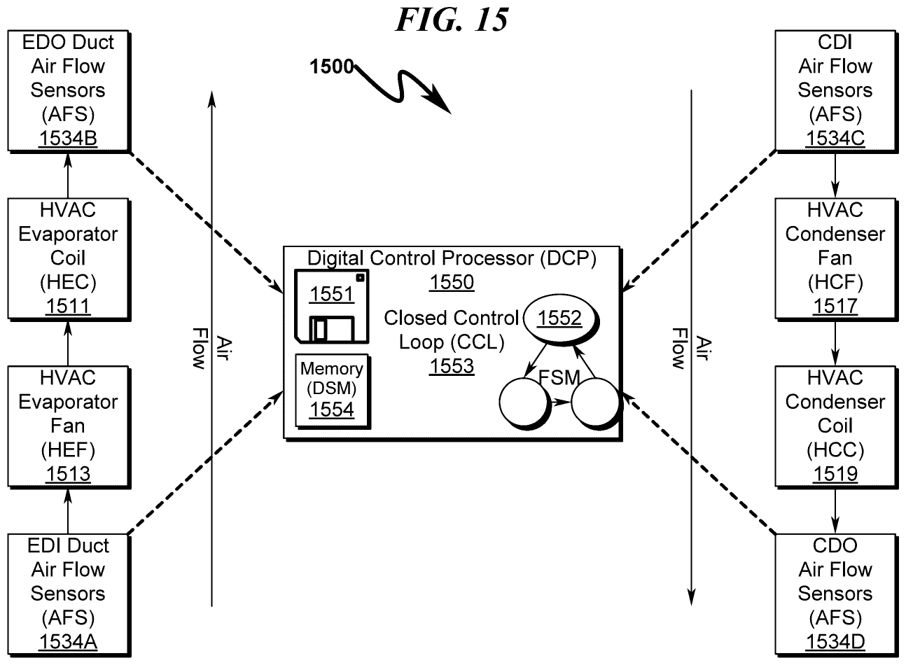

As generally depicted in FIG. 15 (1500), the present invention may incorporate a number of air flow sensors (AFS) (1534A, 1534B, 1534C, 1534D) that are monitored by the DCP (1550) to allow monitoring of air flow within the HVAC evaporator (1511) and/or condenser (1519) components. This pressure monitoring with respect to the evaporator (1511) and/or condenser (1519) permits the detection of air flow restrictions (clogged air filters, dirty evaporator/condenser coils, etc.) in the system or fault conditions such as failures of fan motors degraded operation thereof.

### Alarm Mode Detail (1600)

As generally depicted in FIG. 16 (1600), a detected refrigerant leak may activate an ALARM mode having several ancillary functions. Generally speaking, this ALARM mode may include one or more of the following steps:
(1) opening HER and HCR relay contacts (1601);
(2) closing ERV & CRV valves (1602);
(3) disabling HEF and HCF fans (1603);
(4) enabling an audible alarm (1604);
(5) flashing a LED indicator (1605);
(6) outputting an alarm message to a wireless user interface (WUI) and/or MUD (1606); and/or
(7) waiting in a loop for a hardware system reset (1607).
   These steps may be augmented and/or omitted and rearranged as needed based on system application context. This alarm mode method may be utilized in a wide variety of invention embodiments as described herein.

### Exemplary HRC Fault Detection (1700)-(3200)

While the present invention anticipates a wide variety of methodologies by which fault detection and monitoring can be achieved between a HVAC system component and the DCP, the present invention anticipates that several novel methodologies disclosed herein may be optimal for many system configurations. The present invention incorporates a fault and control comprehensive monitoring system utilizing a finite state machine (FSM) closed control loop (CCL) approach that permits historical and/or range-limited information to determine whether a HVAC fault has occurred while also pinpointing the fault type and allowing for alarms and/or interaction with a field service technician to rapidly isolate and correct the fault condition.

As applied to fault location involving a HVAC relay/contactor (HRC), the following discussion applies. When a coil of a relay/contactor shorts out, the current draw through the coil will increase dramatically due to the very low resistance of the short circuit. This can lead to a situation where the supply voltage (typically sourced may experience a from a 24 VAC transformer secondary) temporary drop because the power supply is now supplying a much higher current than it was designed for.

In many cases, if the power supply is unable to handle the increased current demand, the voltage may drop. However, if the power supply can provide the necessary current, the voltage might stay relatively stable. It is important to note that the coil itself is designed to operate at a specific voltage, and a short circuit can lead to overheating and potential damage to the coil or the power supply.

In the case of a coil short, the transformer primary winding will or could be damaged due to excessive on cycles of power, for example turning on the outdoor condenser. Slow blow fuses are typically used to protect other components like control boards, transformer and blower motors in these scenarios, but there is no guarantee that this fuse protection methodology will prevent a transformer failure in the event of a partial coil short condition.

In summary, a short circuit in the coil will lead to an increase in current draw, and the voltage may drop depending on the power supply's capacity to handle that increased current, and may result in the failure of the power supply transformer. This scenario will apply to all resistive loads, such as coils on relays.

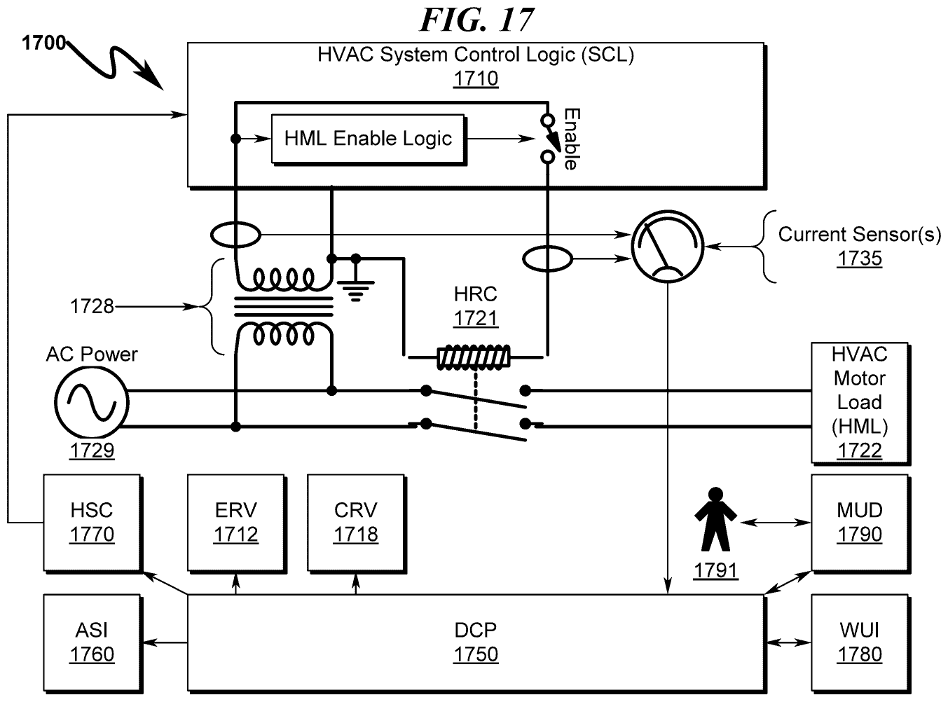

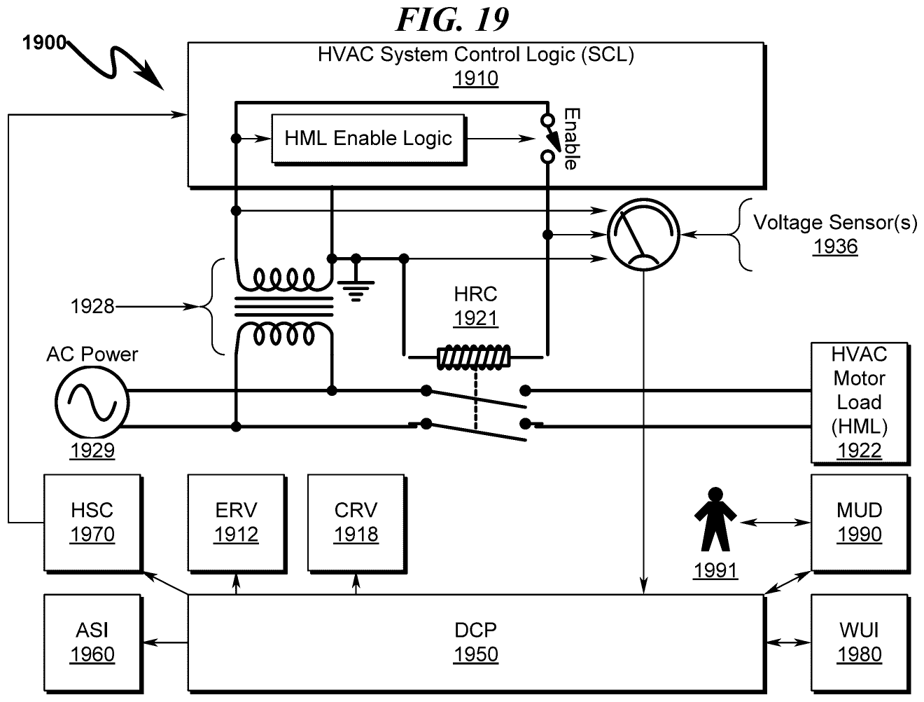

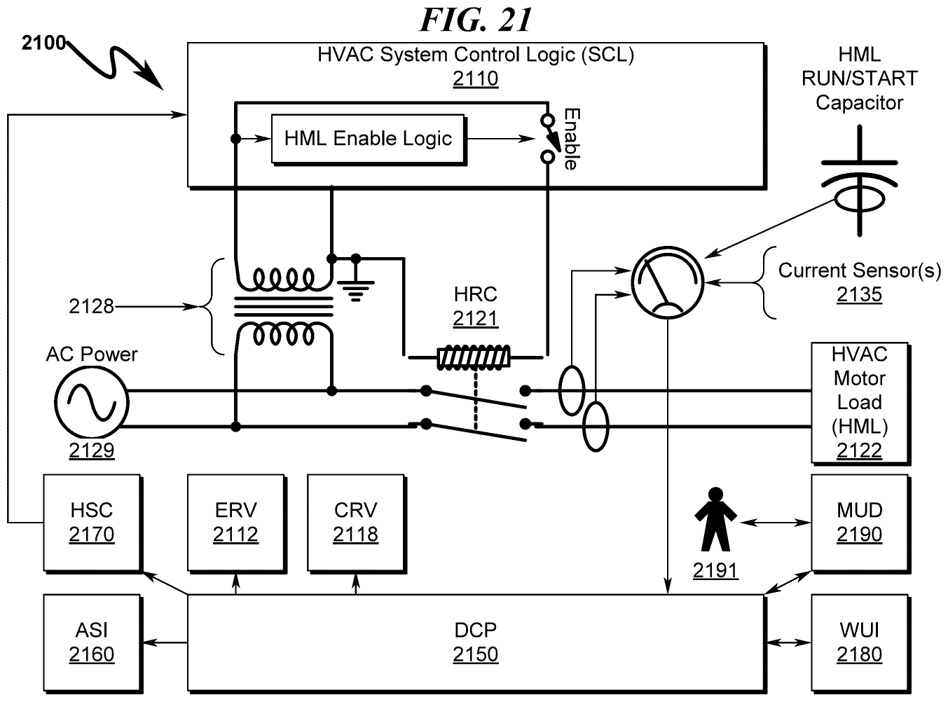

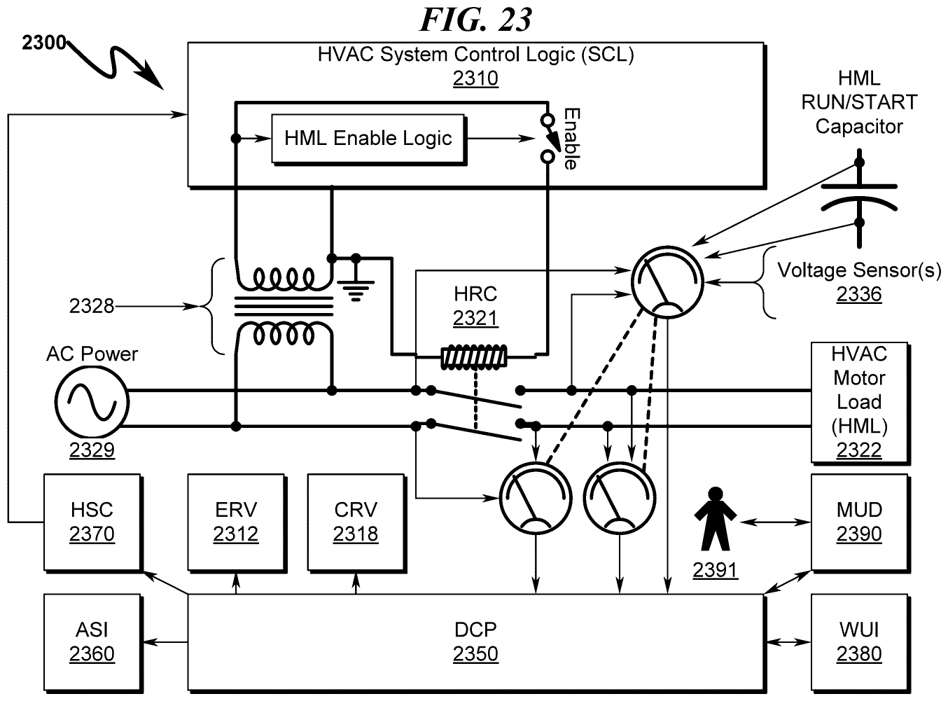

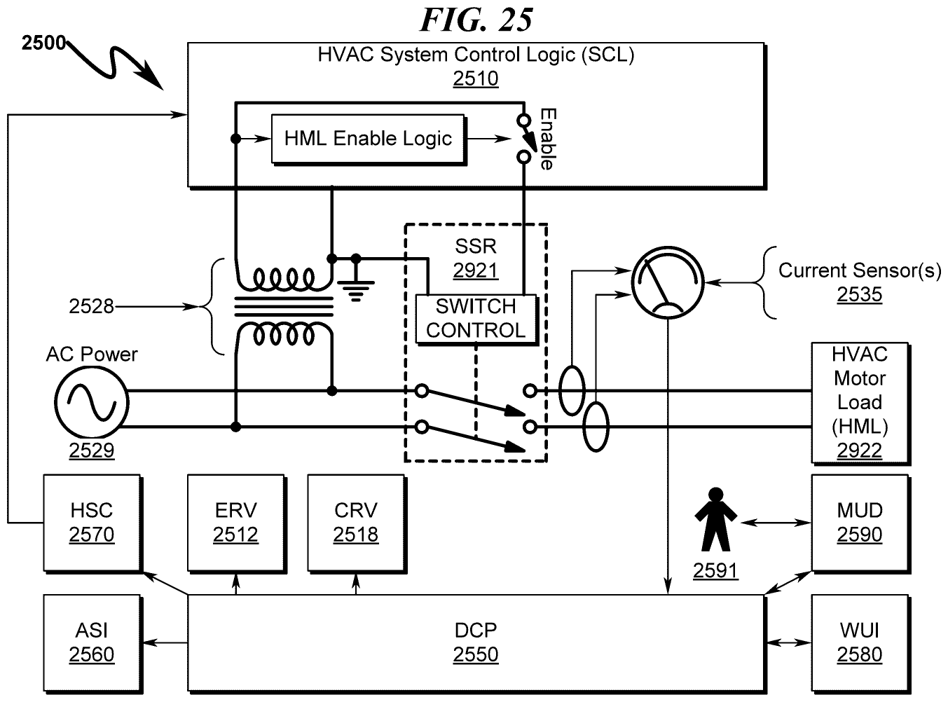

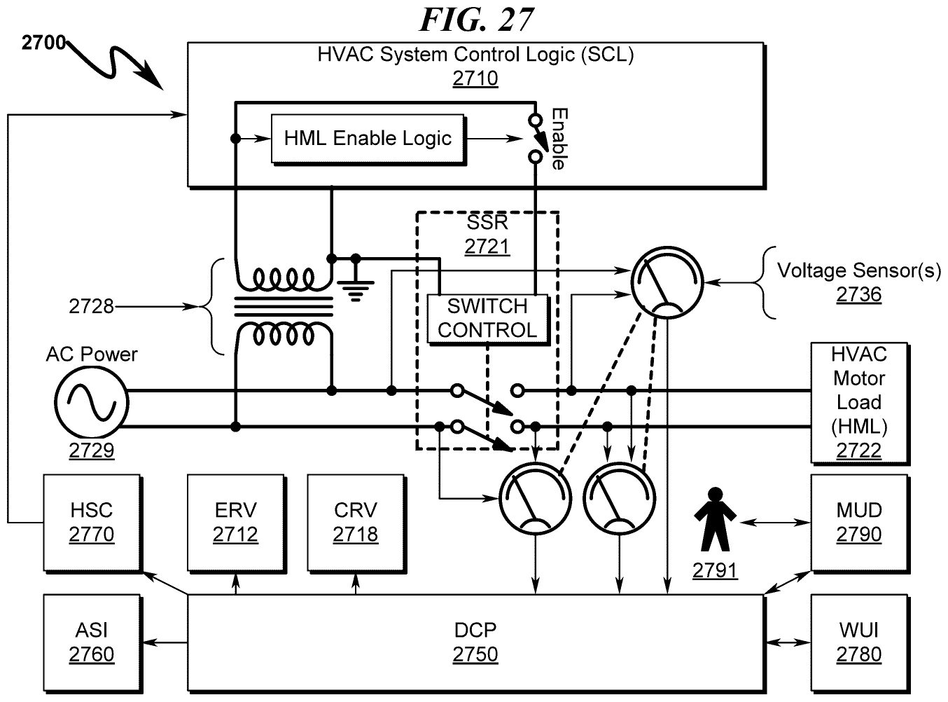

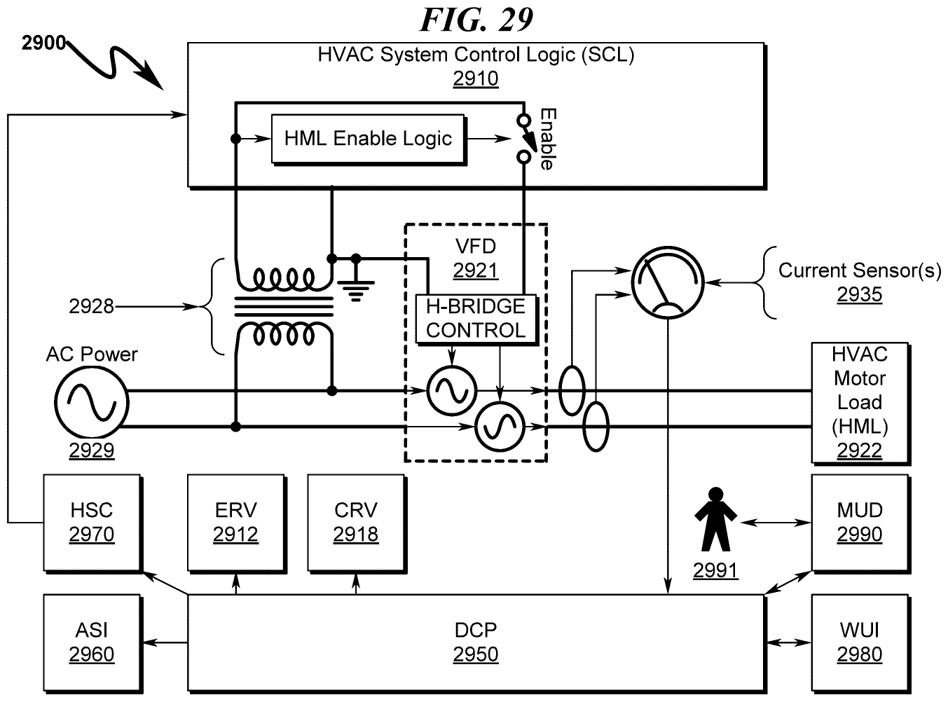

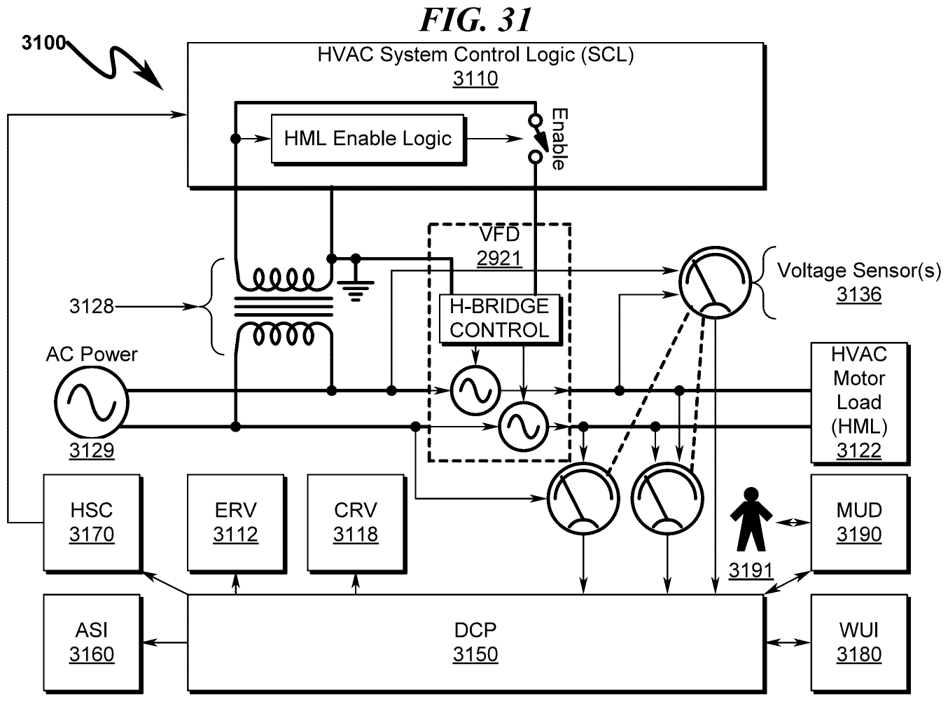

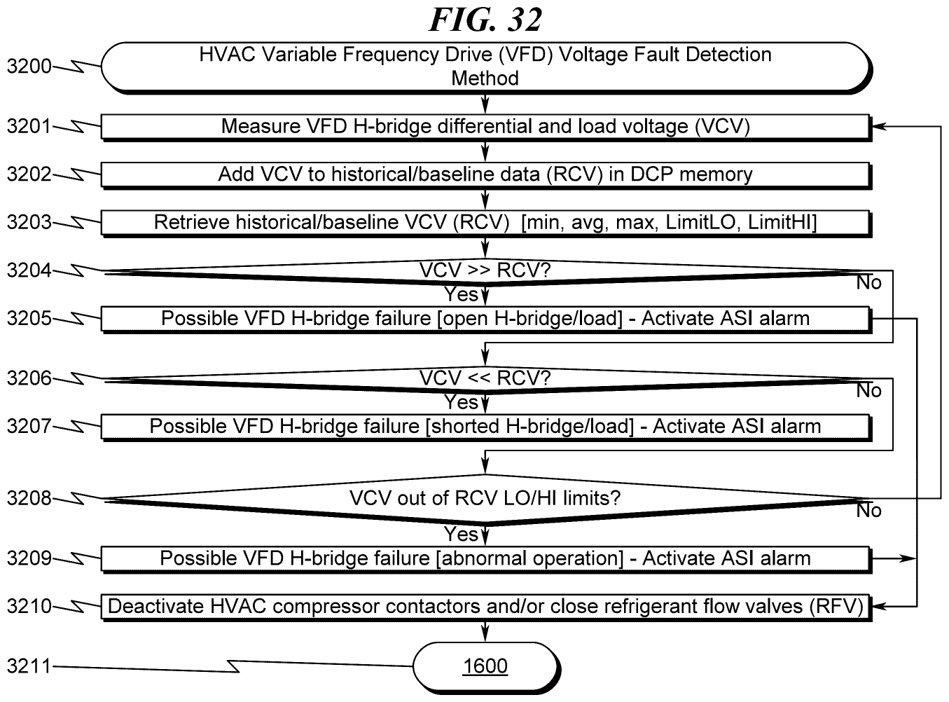

Examples of the present invention system/method as applied to fault location involving a HVAC relay/contactor (HRC) are depicted in FIG. 17 (1700)-FIG. 32 (3200). As seen in the drawings of FIG. 17 (1700), FIG. 19 (1900), FIG. 21 (2100), FIG. 23 (2300), FIG. 25 (2500), FIG. 27 (2700), FIG. 29 (2900), and FIG. 31 (3100), the HVAC system control logic (SCL) (1710, 1910, 2110, 2310, 2510, 2710, 2910, 3110) operates to control activation of a HVAC relay/contactor (HRC)/solid-state-relay (SSR)/variable frequency drive (VFD) (1721, 1921, 2121, 2321, 2521, 2721, 2921, 3121) that enables operation of a HVAC motor load (HML) (1722, 1922, 2122, 2322, 2522, 2722, 2922, 3122). In each of the scenarios depicted, the DCP (1750, 1950, 2150, 2350, 2550, 2750, 2950, 3150) monitors current/voltage sensors (1735, 1936, 2135, 2336, 2535, 2736, 2935, 3136) to determine if a fault has occurred within the context of the HRC/SSR/VED (1721, 1921, 2121, 2321, 2521, 2721, 2921, 3121) or HML (1722, 1922, 2122, 2322, 2522, 2722, 2922, 3122).

Depending on the type of HRC/SSR/VFD fault to be detected, various detection methods may utilize historical sensor data that is stored in the DCP regarding minimum, maximum, or average of prior data readings and/or fixed LO and HI limit data stored in the DCP as reference data regarding typical HRC/HML load performance.

Furthermore, the DCP may also utilize both voltage and current sensor readings to determine if a RUN/START capacitor associated with the HML has failed or has been degraded, as often occurs with the capacitors used in these configurations due to the extreme temperature variations encountered in typical HVAC operational environments.

### HVAC Relay/Contactor (HRC) Coil Current Fault Detection Method (1800)

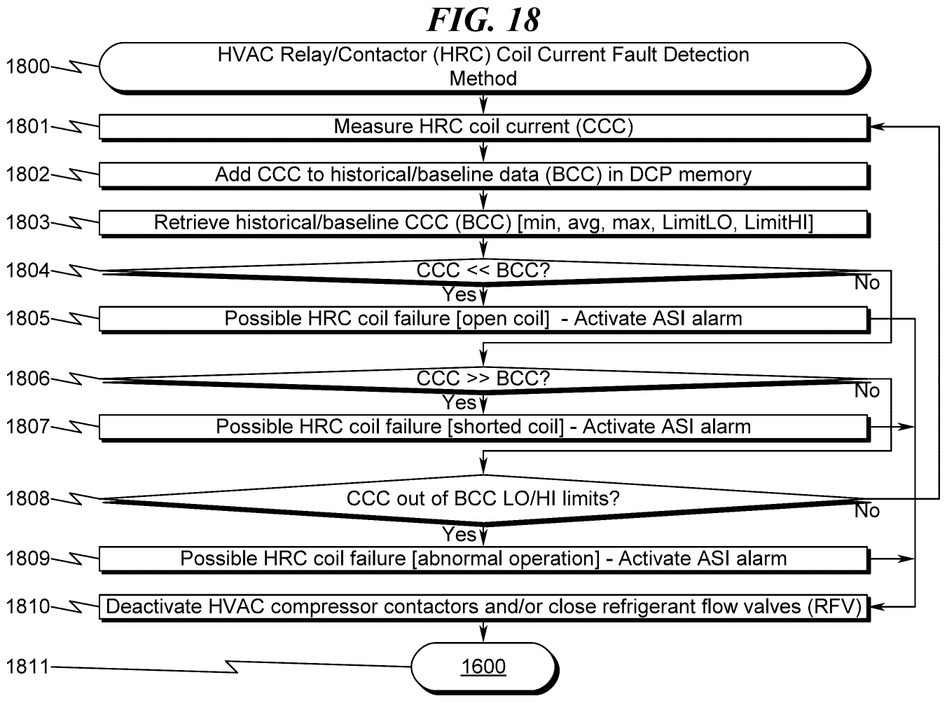

The fault detection system block diagram of FIG. 17 (1700) may be associated with a method depicted in FIG. 18 (1800). As generally depicted in FIG. 18 (1800), the present invention anticipates a HVAC Relay/Contactor (HRC) Coil Current Fault Detection Method comprising the following steps:
(1) with a digital control processor (DCP), measuring HRC coil current (CCC) with one or more current sensors (1801);
(2) with the DCP, adding the CCC to historical/baseline data (BCC) in DCP memory (1802);
(3) with the DCP, retrieving historical/baseline CCC (BCC) [min, avg, max, LimitLO, LimitHI] data from DCP memory (1803);
(4) with the DCP, determining if CCC«BCC, and if not, proceeding to step (6) (1804);
(5) logging a possible HRC coil failure [open coil] and activating an ASI alarm and proceeding to step (10) (1805);
(6) with the DCP, determining if CCC»BCC, and if not, proceeding to step (8) (1806);
(7) logging a possible HRC coil failure [shorted coil] and activating an ASI alarm and proceeding to step (10) (1807);
(8) with the DCP, determining if CCC is out of BCC LO/HI limits, and if not, proceeding to step (1) (1808);
(9) logging a possible HRC coil failure [abnormal operation] and activating an ASI alarm and proceeding to step (10) (1809);
(10) deactivating HVAC relay/contactors (HER/HCR) and/or closing refrigerant flow valves (ERV/CRV) to mitigate component failure in the HVAC system (1810); and
(11) terminating the HRC coil fault detection method and proceeding to the alarm mode method (1600) (1811).
   This general method may be modified heavily depending on a number of factors, with rearrangement and/or addition/deletion of steps anticipated by the scope of the present invention without departing from the teachings of the present invention. Integration of this and other preferred exemplary embodiment methods in conjunction with a variety of preferred exemplary embodiment systems described herein is anticipated by the overall scope of the present invention.

### HVAC Relay/Contactor (HRC) Coil Voltage Fault Detection Method (2000)

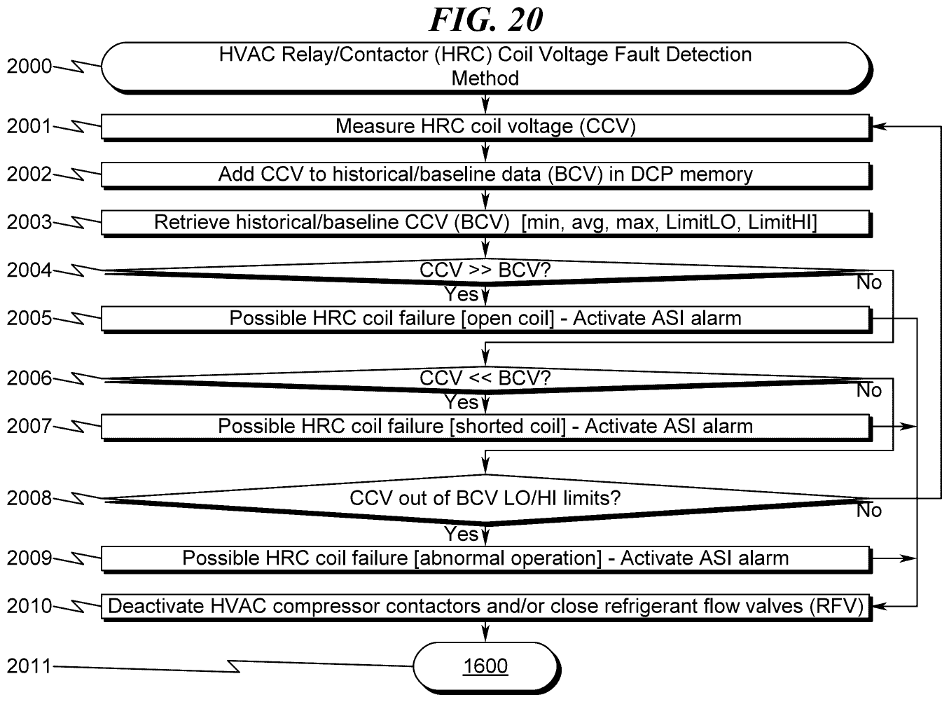

The fault detection system block diagram of FIG. 19 (1900) may be associated with a method depicted in FIG. 20 (2000). As generally depicted in FIG. 20 (2000), the present invention anticipates a HVAC Relay/Contactor (HRC) Coil Voltage Fault Detection Method comprising the following steps:
(1) with a digital control processor (DCP), measuring HRC coil voltage (CCV) with one or more voltage sensors (2001);
(2) with the DCP, adding the CCV to historical/baseline data (BCV) in DCP memory (2002);
(3) with the DCP, retrieving historical/baseline CCV (BCV) [min, avg, max, LimitLO, LimitHI] data from DCP memory (2003);
(4) with the DCP, determining if CCV»BCV, and if not, proceeding to step (6) (2004);
(5) logging a possible HRC coil failure [open coil] and activating an ASI alarm and proceeding to step (10) (2005);
(6) with the DCP, determining if CCV«BCV, and if not, proceeding to step (8) (2006);
(7) logging a possible HRC coil failure [shorted coil] and activating an ASI alarm and proceeding to step (10) (2007);
(8) with the DCP, determining if CCV is out of BCV LO/HI limits, and if not, proceeding to step (1) (2008);
(9) logging a possible HRC coil failure [abnormal operation] and activating an ASI alarm and proceeding to step (10) (2009);
(10) deactivating HVAC relay/contactors (HER/HCR) and/or closing refrigerant flow valves (ERV/CRV) to mitigate component failure in the HVAC system (2010); and
(11) terminating the HRC coil fault detection method and proceeding to the alarm mode method (1600) (2010).

This general method may be modified heavily depending on a number of factors, with rearrangement and/or addition/deletion of steps anticipated by the scope of the present invention without departing from the teachings of the present invention. Integration of this and other preferred exemplary embodiment methods in conjunction with a variety of preferred exemplary embodiment systems described herein is anticipated by the overall scope of the present invention.

### HVAC Relay/Contactor (HRC) Contact Current Fault Detection Method (2200)

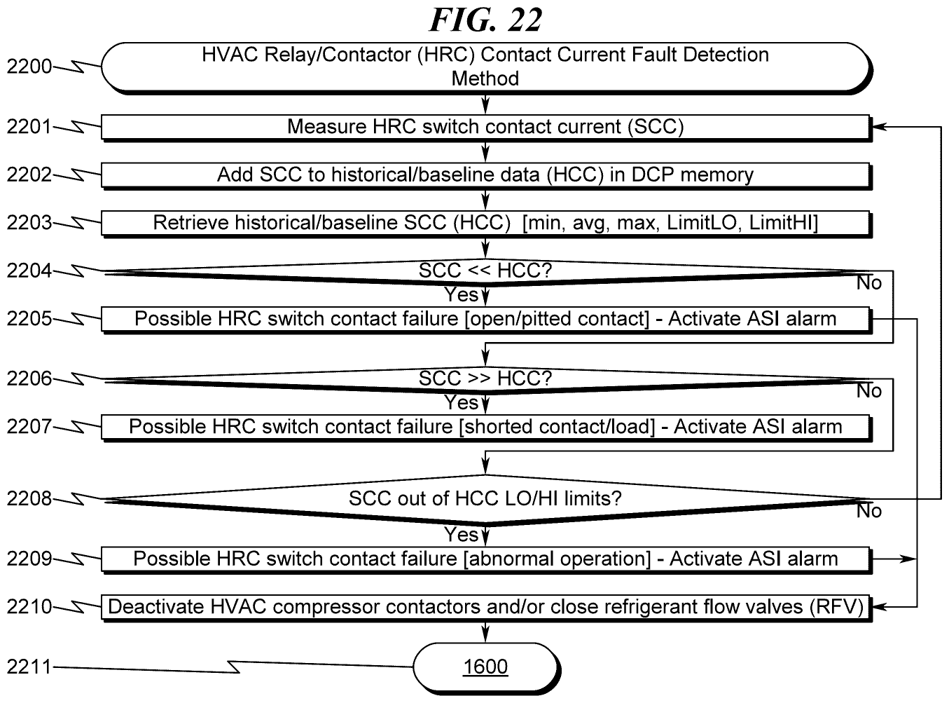

The fault detection system block diagram of FIG. 21 (2100) may be associated with a method depicted in FIG. 22 (2200). As generally depicted in FIG. 22 (2200), the present invention anticipates a HVAC Relay/Contactor (HRC) Contact Current Fault Detection Method comprising the following steps:
(1) with a digital control processor (DCP), measuring HRC switch contact current (SCC) with one or more current sensors (2201);
(2) with the DCP, adding the SCC to historical/baseline data (HCC) in DCP memory (2202);
(3) with the DCP, retrieving historical/baseline SCC (HCC) [min, avg, max, LimitLO, LimitHI] data from DCP memory (2203);
(4) with the DCP, determining if SCC«HCC, and if not, proceeding to step (6) (2204);
(5) logging a possible HRC switch contact failure [open/pitted switch contact] and activating an ASI alarm and proceeding to step (10) (2205);
(6) with the DCP, determining if SCC»HCC, and if not, proceeding to step (8) (2206);
(7) logging a possible HRC switch contact failure [shorted switch contact/load] and activating an ASI alarm and proceeding to step (10) (2207);
(8) with the DCP, determining if SCC is out of HCC LO/HI limits, and if not, proceeding to step (1) (2208);
(9) logging a possible HRC switch contact failure [abnormal operation] and activating an ASI alarm and proceeding to step (10) (2209);
(10) deactivating HVAC relay/contactors (HER/HCR) and/or closing refrigerant flow valves (ERV/CRV) to mitigate component failure in the HVAC system (2210); and
(11) terminating the HRC switch contact fault detection method and proceeding to the alarm mode method (1600) (2211).
   This general method may be modified heavily depending on a number of factors, with rearrangement and/or addition/deletion of steps anticipated by the scope of the present invention without departing from the teachings of the present invention. Integration and other preferred exemplary embodiment methods in conjunction with a variety of preferred exemplary embodiment systems described herein is anticipated by the overall scope of the present invention.

### HVAC Relay/Contactor (HRC) Contact Voltage Fault Detection Method (2400)

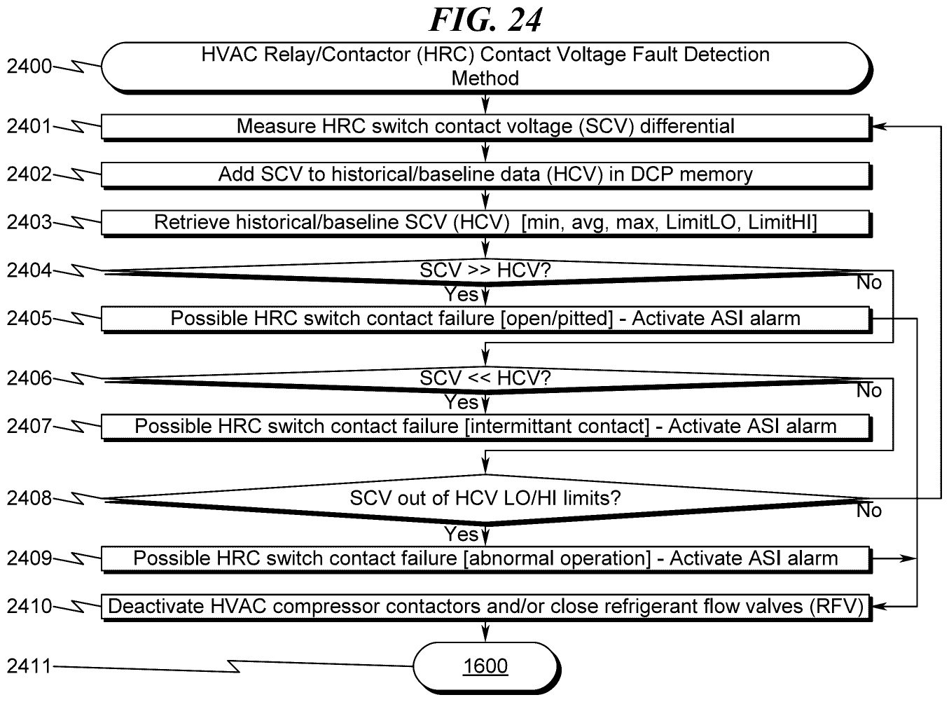

The fault detection system block diagram of FIG. 23 (2300) may be associated with a method depicted in FIG. 24 (2400). As generally depicted in FIG. 24 (2400), the present invention anticipates a HVAC Relay/Contactor (HRC) Contact Voltage Fault Detection Method comprising the following steps:
(1) with a digital control processor (DCP), measuring HRC switch contact and/or HRC load voltages (SCV) with one or more voltage sensors (2401);
(2) with the DCP, adding the SCV to historical/baseline data (HCV) in DCP memory (2402);
(3) with the DCP, retrieving historical/baseline SCV (HCV) [min, avg, max, LimitLO, LimitHI] data from DCP memory (2403);
(4) with the DCP, determining if SCV»HCV, and if not, proceeding to step (6) (2404);
(5) logging a possible HRC switch failure [open/pitted switch contact] and activating an ASI alarm and proceeding to step (10) (2405);
(6) with the DCP, determining if SCV«HCV, and if not, proceeding to step (8) (2406);
(7) logging a possible HRC switch failure [intermittent switch contact] and activating an ASI alarm and proceeding to step (10) (2407);
(8) with the DCP, determining if SCV is out of HCV LO/HI limits, and if not, proceeding to step (1) (2408);
(9) logging a possible HRC switch failure [abnormal operation] and activating an ASI alarm and proceeding to step (10) (2409);
(10) deactivating HVAC relay/contactors (HER/HCR) and/or closing refrigerant flow valves (ERV/CRV) to mitigate component failure in the HVAC system (2410); and
(11) terminating the HRC switch contact fault detection method and proceeding to the alarm mode method (1600) (2410).
   This general method may be modified heavily depending on a number of factors, with rearrangement and/or addition/deletion of steps anticipated by the scope of the present invention without departing from the teachings of the present invention. Integration of this and other preferred exemplary embodiment methods in conjunction with variety of preferred exemplary embodiment systems a described herein is anticipated by the overall scope of the present invention.

### HVAC Solid-State-Relay (SSR) Contact Current Fault Detection Method (2600)

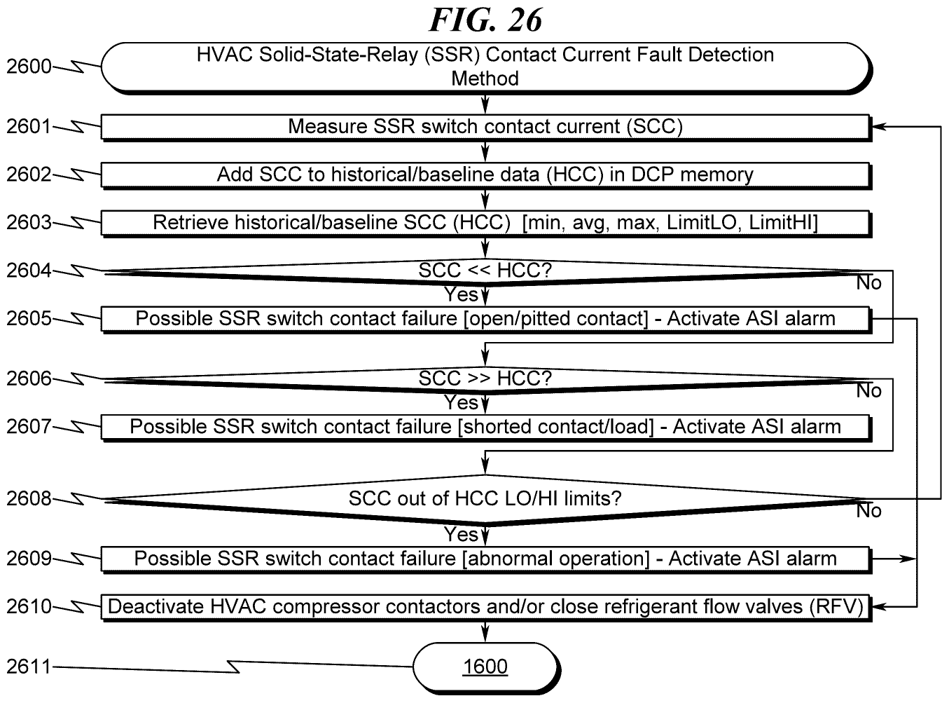

The fault detection system block diagram of FIG. 25 (2500) may be associated with a method depicted in FIG. 26 (2600). As generally depicted in FIG. 26 (2600), the present invention anticipates a HVAC Solid-State-Relay (SSR) Contact Current Fault Detection Method comprising the following steps:
(1) with a digital control processor (DCP), measuring SSR switch contact current (SCC) with one or more current sensors (2601);
(2) with the DCP, adding the SCC to historical/baseline data (HCC) in DCP memory (2602);
(3) with the DCP, retrieving historical/baseline SCC (HCC) [min, avg, max, LimitLO, LimitHI] data from DCP memory (2603);
(4) with the DCP, determining if SCC«HCC, and if not, proceeding to step (6) (2604);
(5) logging a possible SSR switch contact failure [open/pitted contact] and activating an ASI alarm and proceeding to step (10) (2605);
(6) with the DCP, determining if SCC»HCC, and if not, proceeding to step (8) (2606);
(7) logging a possible SSR switch contact failure [shorted contact/load] and activating an ASI alarm and proceeding to step (10) (2607);
(8) with the DCP, determining if SCC is out of HCC LO/HI limits, and if not, proceeding to step (1) (2608);
(9) logging a possible SSR switch contact failure [abnormal operation] and activating an ASI alarm and proceeding to step (10) (2609);
(10) deactivating HVAC relay/contactors (HER/HCR) and/or closing refrigerant flow valves (ERV/CRV) to mitigate component failure in the HVAC system (2610); and
(11) terminating the SSR switch contact fault detection method and proceeding to the alarm mode method (1600) (2611).
   This general method may be modified heavily depending on a number of factors, with rearrangement and/or addition/deletion of steps anticipated by the scope of the present invention without departing from the teachings of the present invention. Integration of this and other preferred exemplary embodiment methods in conjunction with a variety of preferred exemplary embodiment systems described herein is anticipated by the overall scope of the present invention.

### HVAC Solid-State-Relay (SSR) Contact Voltage Fault Detection Method (2800)

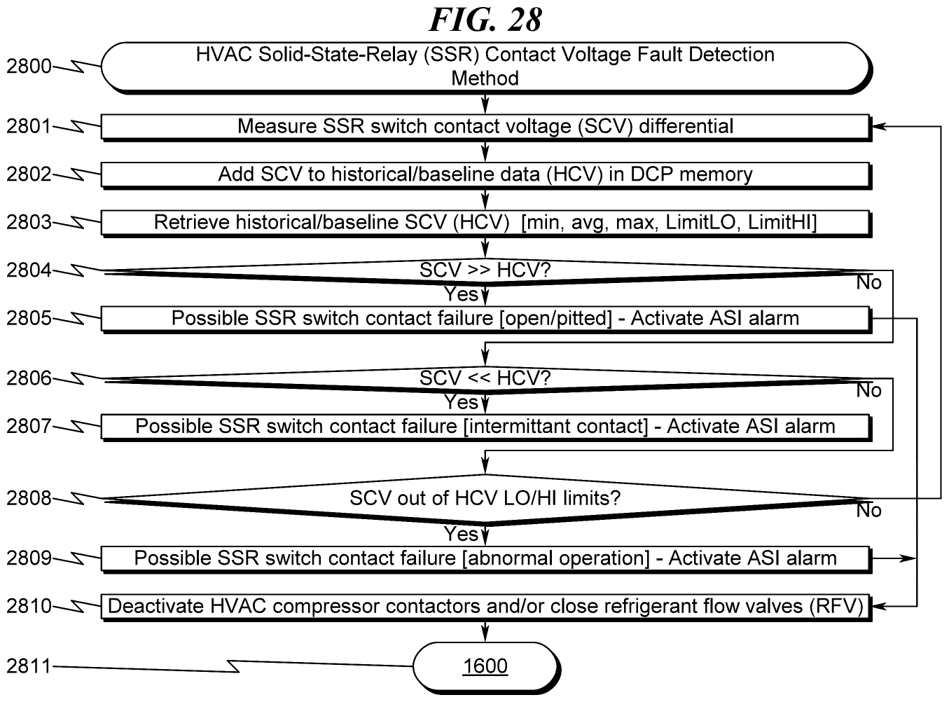

The fault detection system block diagram of FIG. 27 (2700) may be associated with a method depicted in FIG. 28 (2800). As generally depicted in FIG. 28 (2800), the present invention anticipates a HVAC Solid-State-Relay (SSR) Contact Voltage Fault Detection Method comprising the following steps:
(1) with a digital control processor (DCP), measuring SSR switch contact and/or SSR load voltages (SCV) with one or more voltage sensors (2801);
(2) with the DCP, adding the SCV to historical/baseline data (HCV) in DCP memory (2802);
(3) with the DCP, retrieving historical/baseline SCV (HCV) [min, avg, max, LimitLO, LimitHI] data from DCP memory (2803);
(4) with the DCP, determining if SCV»HCV, and if not, proceeding to step (6) (2804);
(5) logging a possible SSR switch failure [open/failed contact] and activating an ASI alarm and proceeding to step (10) (2805);
(6) with the DCP, determining if SCV«HCV, and if not, proceeding to step (8) (2806);
(7) logging a possible SSR switch failure [intermittent/weak contact] and activating an ASI alarm and proceeding to step (10) (2807);
(8) with the DCP, determining if SCV is out of HCV LO/HI limits, and if not, proceeding to step (1) (2808);
(9) logging a possible SSR switch failure [abnormal operation] and activating an ASI alarm and proceeding to step (10) (2809);
(10) deactivating HVAC relay/contactors (HER/HCR) and/or closing refrigerant flow valves (ERV/CRV) to mitigate component failure in the HVAC system (2810); and
(11) terminating the SSR switch contact fault detection method and proceeding to the alarm mode method (1600) (2810).
   This general method may be modified heavily depending on a number of factors, with rearrangement and/or addition/deletion of steps anticipated by the scope of the present invention without departing from the teachings of the present invention. Integration of this and other preferred exemplary embodiment methods in conjunction with a variety of preferred exemplary embodiment systems described herein is anticipated by the overall scope of the present invention.

### HVAC Variable Frequency Drive (VFD) Current Fault Detection Method (3000)

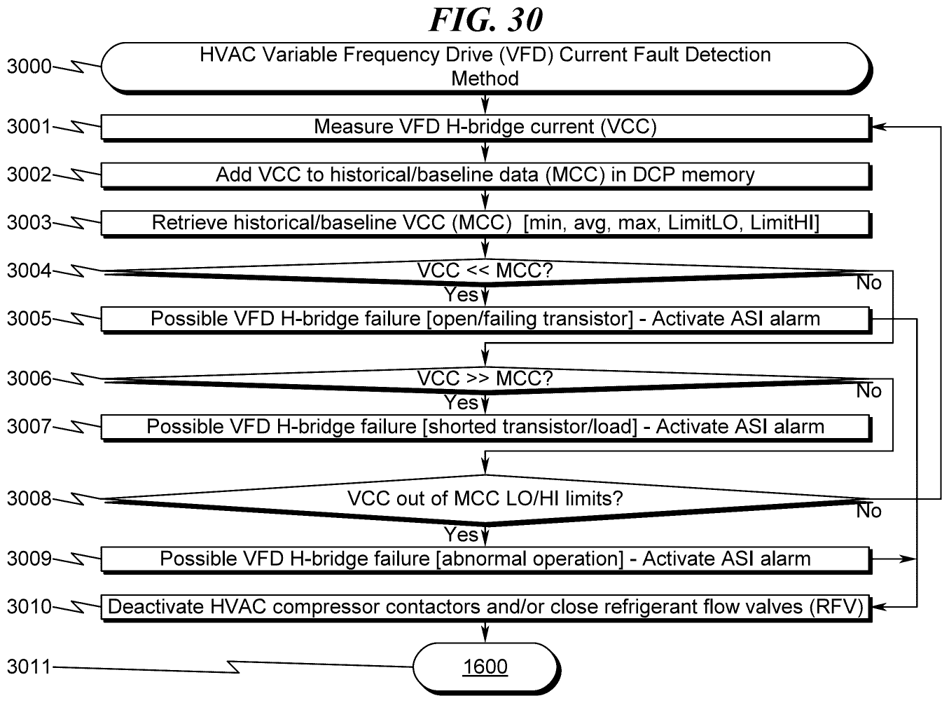

The fault detection system block diagram of FIG. 29 (2900) may be associated with a method depicted in FIG. 30 (3000). As generally depicted in FIG. 30 (3000), the present invention anticipates a HVAC Variable Frequency Drive (VFD) Current Fault Detection Method comprising the following steps:
(1) with a digital control processor (DCP), measuring VFD H-BRIDGE current (VCC) with one or more current sensors (3001);
(2) with the DCP, adding the VCC to historical/baseline data (MCC) in DCP memory (3002);
(3) with the DCP, retrieving historical/baseline VCC (MCC) [min, avg, max, LimitLO, LimitHI] data from DCP memory (3003);
(4) with the DCP, determining if VCC«MCC, and if not, proceeding to step (6) (3004);
(5) logging a possible VED H-BRIDGE failure [open H-BRIDGE/FAILING TRANSISTOR] and activating an ASI alarm and proceeding to step (10) (3005);
(6) with the DCP, determining if VCC»MCC, and if not, proceeding to step (8) (3006);
(7) logging a possible VFD H-BRIDGE failure [shorted H-BRIDGE TRANSISTOR/LOAD] and activating an ASI alarm and proceeding to step (10) (3007);
(8) with the DCP, determining if VCC is out of MCC LO/HI limits, and if not, proceeding to step (1) (3008);
(9) logging a possible VFD failure [abnormal operation] and activating an ASI alarm and proceeding to step (10) (3009);
(10) deactivating HVAC relay/contactors (HER/HCR) and/or closing refrigerant flow valves (ERV/CRV) to mitigate component failure in the HVAC system (3010); and
(11) terminating the VFD switch contact fault detection method and proceeding to the alarm mode method (1600) (3011).
   This general method may be modified heavily depending on a number of factors, with rearrangement and/or addition/deletion of steps anticipated by the scope of the present invention without departing from the teachings of the present invention. Integration of this and other preferred exemplary embodiment methods in conjunction with a variety of preferred exemplary embodiment systems described herein is anticipated by the overall scope of the present invention.

### HVAC Variable Frequency Drive (VFD) Voltage Fault Detection Method (3200)

The fault detection system block diagram of FIG. 31 (3100) may be associated with a method depicted in FIG. 32 (3200). As generally depicted in FIG. 32 (3200), the present invention anticipates a HVAC Variable Frequency Drive (VFD) Voltage Fault Detection Method comprising the following steps:
(1) with a digital control processor (DCP), measuring VFD H-BRIDGE and/or VFD load voltages (VCV) with one or more voltage sensors (3201);
(2) with the DCP, adding the VCV to historical/baseline data (RCV) in DCP memory (3202);
(3) with the DCP, retrieving historical/baseline VCV (RCV) [min, avg, max, LimitLO, LimitHI] data from DCP memory (3203);
(4) with the DCP, determining if VCV»RCV, and if not, proceeding to step (6) (3204);
(5) logging a possible VFD H-BRIDGE failure [open H-BRIDGE/LOAD] and activating an ASI alarm and proceeding to step (10) (3205);
(6) with the DCP, determining if VCV«RCV, and if not, proceeding to step (8) (3206);
(7) logging a possible VFD H-BRIDGE failure [intermittent H-BRIDGE/LOAD] and activating an ASI alarm and proceeding to step (10) (3207);
(8) with the DCP, determining if VCV is out of RCV LO/HI limits, and if not, proceeding to step (1) (3208);
(9) logging a possible VFD [abnormal operation] and activating an ASI alarm and proceeding to step (10) (3209);
(10) deactivating HVAC relay/contactors (HER/HCR) and/or closing refrigerant flow valves (ERV/CRV) to mitigate component failure in the HVAC system (3210); and
(11) terminating the VFD switch contact fault detection method and proceeding to the alarm mode method (1600) (3210).
   This general method may be modified heavily depending on a number of factors, with rearrangement and/or addition/deletion of steps anticipated by the scope of the present invention without departing from the teachings of the present invention. Integration of this and other preferred exemplary embodiment methods in conjunction with a variety of preferred exemplary embodiment systems described herein is anticipated by the overall scope of the present invention.

### Exemplary HVAC Motor Load (HML) Capacitor Fault Detection

Generally speaking, some or all HML devices used within the HVAC system (evaporator fan motors, condenser fan motors, and compressor motors) may utilize RUN and/or START capacitors in their operation. A critical component of capacitor failure in this environment is the fact that the failure is exhibited as degraded performance over time that may also be temperature-dependent. The failure mechanisms typically exhibit themselves as reduced effective capacitance (open plates), shorted capacitor (shorted plates), and increased internal series resistance (dielectric degradation). The failure and/or degradation of RUN/START capacitors in this environment is a well-known fault mechanism in the industry that has yet to be addressed by prior art monitoring and control systems.

The system/method presented in FIG. 17 (1700)-FIG. 32 (3200) may be utilized to detect RUN/START capacitor faults associated with the HVAC Motor Load (HML) in some preferred embodiments that are applied to HVAC systems incorporating RUN/START capacitors on various HMLS. Depictions of this configuration are shown in FIG. 21 (2100) and FIG. 23 (2300). In these scenarios, the current flow and voltage potential monitoring techniques described above may be applied to the RUN and/or START capacitors associated with the HML to monitor instantaneous capacitor current flow (CCF) and capacitor voltage potential (CVP). Here a current flow sensor is used to detect current flow thru a RUN/START capacitor and voltage potential sensors are used to detect a differential voltage across the capacitor plates. The instantaneous phase angle between the capacitor current and capacitor voltage can be used to determine both the effective capacitance of the capacitor being tested and also the internal series resistance of the capacitor under test.

Since a common failure mechanism in HVAC systems is the degradation and/or failure of RUN/START capacitors associated with fan motors and/or compressor motors, the a (reduced effective ability to determine failure capacitance, open plates, shorted/resistive plates, increased internal series resistance) in these capacitors or degradation in their performance (due to heat, age, etc.) can be used by the DCP to trigger an ASI alarm indicating the need for HVAC maintenance or complete failure of the capacitor under test dictating the need for a HVAC shutdown sequence to prevent damage to fan and/or compressor motors.

### Application to Heat Mode Compressor Operation

The present invention system and method described herein are shown in the context of a typical HVAC system operation in COOL mode where the evaporator/compressor/condenser combination is configured to cool the interior of a building structure. The invention teachings may be equally applied to HVAC system operation in HEAT mode where condenser combination is the evaporator/compressor/configured to heat the interior of a building structure. In these configurations a condenser reversing valve (CRV) is incorporated in the compressor/condenser configuration to reverse heat flow and enable the evaporator to collect heat from outside the building structure and deposit it within the interior of the building structure. One skilled in the art will no doubt realize this duality within the teachings of the present invention and be able to modify the teachings herein to apply them HVAC systems operating in HEAT mode.

### MCS System Summary

The present invention system may be broadly generalized as a monitoring and control system (MCS) for use in heating, ventilation, and air conditioning (HVAC) systems consisting of evaporator elements and condenser elements, the MCS comprising:
(a) operational state sensors (OSS);
(b) digital control processor (DCP); and
(c) alarm status indicator (ASI);
wherein:
the Oss are individually positioned within the HVAC system and configured to detect a measured operational state (MOS) of the HVAC system;
the OSS communicates the MOS to the DCP;
the DCP operates a closed control loop (CCL) that continuously monitors the MOS received from the OSS;
the CCL stores the MOS in a digital state memory (DSM);
the CCL compares the MOS to previously stored data (PSD) in the DSM;
the DCP triggers activation of the ASI in the event that the comparison indicates that the MOS deviates from a predetermined value or is outside a predetermined range of values in the DSM; and
the OSS are selected from a group consisting of: refrigerant gas sensor (RGS), refrigerant temperature sensor (RTS), refrigerant pressure sensor (RPS), air flow sensor (AFS), ambient temperature sensor (ATS), ambient humidity sensor (AHS), current flow sensor (CFS), and voltage potential sensor (VPS).

This general system summary may be augmented by the various elements described herein to produce a wide variety of invention embodiments consistent with this overall design description.

### System/Method Variations

The present invention anticipates a wide variety of variations in the basic theme of construction. The examples presented previously do not represent the entire scope of possible usages. They are meant to cite a few of the almost limitless possibilities.

This basic system and method may be augmented with a variety of ancillary embodiments, including but not limited to:
An embodiment wherein the evaporator elements comprise an evaporator refrigerant valve (EFV), HVAC evaporator coil (HEC), HVAC evaporator fan (HEF), and HVAC evaporator relay (HER).
An embodiment wherein the condenser elements comprise a condenser refrigerant valve (CRV), HVAC condenser coil (HCC), HVAC condenser fan (HCF), HVAC compressor motor (HCM), and HVAC condenser relay (HCR).
An embodiment wherein the THS comprises a thermistor.
An embodiment wherein the THS comprises a solid-state temperature sensor electrically coupled to a 1-wire temperature sensor bus.
An embodiment wherein the RTS and the RPS are integrated into a single unit mechanically coupled to one or more of the evaporator and/or the condenser elements within the HVAC system.
An embodiment wherein activation of the ASI triggers activation of a HVAC shutdown control (HSC) that disables operation of the HVAC system.
An embodiment wherein activation of the ASI triggers an error message sent by the DCP to a wireless user interface (WUI) and/or a mobile user device (MUD).
An embodiment wherein the MOS comprises a differential temperature/pressure matrix (MTP) that logs differential temperatures and/or pressures within the HVAC system.
An embodiment wherein the CFS is configured to measure current flow in a HVAC load, the load selected from a group consisting of: relay/contactor (HRC) connected coil; relay/contactor (HRC) connected motor load (HML); solid-state relay (SSR) connected motor load (HML); and variable-frequency-drive (VED) H-bridge connected motor load (HML).
An embodiment wherein the VPS is configured to measure voltage potential at a HVAC load, the load selected from a group consisting of: relay/contactor (HRC) connected coil; relay/contactor (HRC) connected motor load (HML); relay/contactor (HRC) switch contacts; solid-state relay (SSR) connected motor load (HML); solid-state relay (SSR) switch contact; and variable-frequency-drive (VFD) H-bridge connected motor load (HML).
An embodiment wherein the CCL in the DCP is configured to store timestamped RUN current MOS values in the DSM when the HVAC system is operational.
An embodiment wherein the CCL in the DCP is configured to store RUN current, minimum, average, maximum, and standard deviation MOS values in the DSM when the HVAC system is operational.
An embodiment wherein the CCL in the DCP is configured to store timestamped IDL current MOS values in the DSM when the HVAC system is not operational.
An embodiment wherein the CCL in the DCP is configured to store IDL current, minimum, average, maximum, and standard deviation MOS values in the DSM when the HVAC system is not operational.
An embodiment wherein the DSM contains LimitLO and LimitHI values that are compared to the MOS by the CCL within the DCP and the DCP is configured to trigger the ASI if the MOS deviates outside the range of the LimitLO value or the LimitHI value.
An embodiment further comprising a wireless user interface (WUI) electrically coupled to the DCP that allows remote communication with a mobile user device (MUD) for the purposes of remotely monitoring and controlling the HVAC system using the DCP.
An embodiment further comprising a HVAC shutdown control (HSC) configured to halt operation of the HVAC system when activated by the DCP on the detection of a HVAC fault condition.
An embodiment further comprising evaporator flow valves (EFV) and condenser flow valves (CFV) that are electrically coupled to the DCP and closed in the event that the DCP detects a refrigerant leak condition in the HVAC system.
An embodiment wherein:
   the DCP controls operation of HVAC motor loads (HML) in the HVAC system via the use of motor control actuators (MCA);
   the MCA are selected from a group consisting of: relay/contactors; solid-state relays (SSR); and variable-frequency-drive (VFD) H-bridges; and
   the DCP operates to deactivate the MCA in the event of a detected fault in the HVAC system and/or detected degraded operation of the HVAC system.

One skilled in the art will recognize that other embodiments are possible based on combinations of elements taught within the above invention description.

### CONCLUSION

A monitoring and control system/method for use in heating, ventilation, and air conditioning (HVAC) systems has been disclosed that incorporates a digital control processor (DCP) controlling and monitoring the operation of a HVAC system incorporating evaporator elements (refrigerant valve (EFV), coil (HEC), fan (HEF), relay (HER)) and condenser elements (refrigerant valve (CRV), coil (HCC), fan (HCF), compressor motor (HCM), relay (HCR)) via a sensor/control bus. The HVAC elements may be monitored by the DCP using sensors measuring ambient refrigerant gas (RGS), refrigerant temperature (RTS), refrigerant pressure (RPS), duct air flow (AFS), ambient temperature/humidity (THS), and operational current/voltage (CVS). The DCP is configured to activate an alarm status indicator (ASI) and HVAC shutdown control (HSC) in the event of a detected HVAC system fault and interact with a wireless user interface (WUI) and mobile user device (MUD) to enable remote monitoring and control of the HVAC system.

### CLAIMS INTERPRETATION

The following rules apply when interpreting the CLAIMS of the present invention:
The CLAIM PREAMBLE should be considered as limiting the scope of the claimed invention.
“WHEREIN” clauses should be considered as limiting the scope of the claimed invention.
“WHEREBY” clauses should be considered as limiting the scope of the claimed invention.
“ADAPTED TO” clauses should be considered as limiting the scope of the claimed invention.
“ADAPTED FOR” clauses should be considered as limiting the scope of the claimed invention.
The term “MEANS” specifically invokes the means-plus-function claims limitation recited in 35 U.S.C. § 112 (f) and such claim shall be construed to cover the corresponding structure, material, or acts described in the specification and equivalents thereof.
The phrase “MEANS FOR” specifically invokes the means-plus-function claims limitation recited in 35 U.S.C. § 112 (f) and such claim shall be construed to cover the corresponding structure, material, or acts described in the specification and equivalents thereof.
The phrase “STEP FOR” specifically invokes the step-plus-function claims limitation recited in 35 U.S.C. § 112 (f) and such claim shall be construed to cover the corresponding structure, material, or acts described in the specification and equivalents thereof.
The step-plus-function claims limitation recited in 35 U.S.C. § 112 (f) shall be construed to cover the corresponding structure, material, or acts described in the specification and equivalents thereof ONLY for such claims including the phrases “MEANS FOR”, “MEANS”, or “STEP FOR”.
The phrase “AND/OR” in the context of an expression “X and/or Y” should be interpreted to define the set of “(X and Y)” in union with the set “(X or Y)” as interpreted by Ex Parte Gross (USPTO Patent Trial and Appeal Board, Appeal 2011-004811, S/N 11/565, 411, (“‘and/or’ covers embodiments having element A alone, B alone, or elements A and B taken together”).
The claims presented herein are to be interpreted in light of the specification and drawings presented herein with sufficiently narrow scope such as to not preempt any abstract idea.
The claims presented herein are to be interpreted in light of the specification and drawings presented herein with sufficiently narrow scope such as to not preclude every application of any idea.
The claims presented herein are to be interpreted in light of the specification and drawings presented herein with sufficiently narrow scope such as to preclude any basic mental process that could be performed entirely in the human mind.
The claims presented herein are to be interpreted in light of the specification and drawings presented herein with sufficiently narrow scope such as to preclude any process that could be performed entirely by human manual effort.

Although a preferred embodiment of the present invention has been illustrated in the accompanying drawings and described in the foregoing detailed description, it will be understood that the invention is not limited to the embodiments disclosed, is but capable of numerous rearrangements, modifications, and substitutions without departing from the spirit of the invention as set forth and defined by the following claims.

What is claimed is:

1. A monitoring and control system (MCS) for use in heating, ventilation, and air conditioning (HVAC) systems consisting of evaporator elements and condenser elements, said MCS comprising:
(a) operational state sensors (OSS);
(b) digital control processor (DCP); and
(c) alarm status indicator (ASI);
wherein:
said OSS are individually positioned within said HVAC system and configured to detect a measured operational state (MOS) of said HVAC system;
said OSS communicates said MOS to said DCP;
said DCP operates a closed control loop (CCL) that continuously monitors said MOS received from said OSS;
said CCL stores said MOS in a digital state memory (DSM);
said CCL compares said MOS to previously stored data (PSD) in said DSM;
said DCP triggers activation of said ASI in the event that said comparison indicates that said MOS deviates from a predetermined value or is outside a predetermined range of values in said DSM; and
said OSS are selected from a group consisting of: refrigerant gas sensor (RGS), refrigerant temperature sensor (RTS), refrigerant pressure sensor (RPS), air flow sensor (AFS), ambient temperature sensor (ATS), ambient humidity sensor (AHS), current flow sensor (CFS), and voltage potential sensor (VPS).

2. The monitoring and control system (MCS) of claim 1 wherein said evaporator elements comprise an evaporator refrigerant valve (EFV), HVAC evaporator coil (HEC), HVAC evaporator fan (HEF), and HVAC evaporator relay (HER).

3. The monitoring and control system (MCS) of claim wherein said condenser elements comprise a condenser refrigerant valve (CRV), HVAC condenser coil (HCC), HVAC condenser fan (HCF), HVAC compressor motor (HCM), and HVAC condenser relay (HCR).

4. The monitoring and control system (MCS) of claim 1 wherein said THS comprises a thermistor.

5. The monitoring and control system (MCS) of claim 1 wherein said THS comprises a solid-state temperature sensor electrically coupled to a 1-wire temperature sensor bus.

6. The monitoring and control system (MCS) of claim 1 wherein said RTS and said RPS are integrated into a single unit mechanically coupled to one or more of said evaporator and/or said condenser elements within said HVAC system.

7. The monitoring and control system (MCS) of claim 1 wherein activation of said ASI triggers activation of a HVAC shutdown control (HSC) that disables operation of said HVAC system.

8. The monitoring and control system (MCS) of claim 1 wherein activation of said ASI triggers an error message sent by said DCP to a wireless user interface (WUI) and/or a mobile user device (MUD).

9. The monitoring and control system (MCS) of claim 1 wherein said MOS comprises a differential temperature/pressure matrix (MTP) that logs differential temperatures and/or pressures within said HVAC system.

10. The monitoring and control system (MCS) of claim 1 wherein said CFS is configured to measure current flow in a HVAC load, said load selected from a group consisting of: relay/contactor (HRC) connected coil; relay/contactor (HRC) connected motor load (HML); solid-state relay (SSR) connected motor load (HML); and variable-frequency-drive (VFD) H-bridge connected motor load (HML).

11. The monitoring and control system (MCS) of claim 1 wherein said VPS is configured to measure voltage potential at a HVAC load, said load selected from a group consisting of: relay/contactor (HRC) connected coil; relay/contactor (HRC) connected motor load (HML); relay/contactor (HRC) switch contacts; solid-state relay (SSR) connected motor load (HML); solid-state relay (SSR) switch contact; and variable-frequency-drive (VFD) H-bridge connected motor load (HML).

12. The monitoring and control system (MCS) of claim 1 wherein said CCL in said DCP is configured to store timestamped RUN current MOS values in said DSM when said HVAC system is operational.

13. The monitoring and control system (MCS) of claim 1 wherein said CCL in said DCP is configured to store RUN current, minimum, average, maximum, and standard deviation MOS values in said DSM when said HVAC system is operational.

14. The monitoring and control system (MCS) of claim 1 wherein said CCL in said DCP is configured to store timestamped IDL current MOS values in said DSM when said HVAC system is not operational.

15. The monitoring and control system (MCS) of claim 1 wherein said CCL in said DCP is configured to store IDL current, minimum, average, maximum, and standard deviation MOS values in said DSM when said HVAC system is not operational.

16. The monitoring and control system (MCS) of claim 1 wherein said DSM contains LimitLO and LimitHI values that are compared to said MOS by said CCL within said DCP and said DCP is configured to trigger said ASI if said MOS deviates outside the range of said LimitLO value or said LimitHI value.

17. The monitoring and control system (MCS) of claim 1 further comprising a wireless user interface (WUI) electrically coupled to said DCP that allows remote communication with a mobile user device (MUD) for the purposes of remotely monitoring and controlling said HVAC system using said DCP.

18. The monitoring and control system (MCS) of claim 1 further comprising a HVAC shutdown control (HSC) configured to halt operation of said HVAC system when activated by said DCP on the detection of a HVAC fault condition.

19. The monitoring and control system (MCS) of claim 1 further comprising evaporator flow valves (EFV) and condenser flow valves (CFV) that are electrically coupled to said DCP and closed in the event that said DCP detects a refrigerant leak condition in said HVAC system.

20. The monitoring and control system (MCS) of claim 1 wherein:
said DCP controls operation of HVAC motor loads (HML) in said HVAC system via the use of motor control actuators (MCA);
said MCA are selected from a group consisting of: relay/contactors; solid-state relays (SSR); and variable-frequency-drive (VFD) H-bridges; and
said DCP operates to deactivate said MCA in the event of a detected fault in said HVAC system and/or detected degraded operation of said HVAC system.
